(19) United States
(12) Patent Application Publication
(10) Pub. No.: US 2022/0321191 A1
(43) Pub. Date: Oct. 6, 2022

(54) METHOD AND APPARATUS FOR SIDELINK COMMUNICATION

(71) Applicant: ELECTRONICS AND TELECOMMUNICATIONS RESEARCH INSTITUTE, Daejeon (KR)

(72) Inventors: Cheul Soon KIM, Daejeon (KR); Sung Hyun MOON, Daejeon (KR); Jung Hoon LEE, Daejeon (KR)

(73) Assignee: ELECTRONICS AND TELECOMMUNICATIONS RESEARCH INSTITUTE, Daejeon (KR)

(21) Appl. No.: 17/845,944

(22) Filed: Jun. 21, 2022

Related U.S. Application Data
(63) Continuation of application No. 16/918,767, filed on Jul. 1, 2020.

(30) Foreign Application Priority Data
Jul. 3, 2019 (KR) 10-2019-0079958
Jul. 11, 2019 (KR) 10-2019-0084050
Jul. 17, 2019 (KR) 10-2019-0086617
Aug. 30, 2019 (KR) 10-2019-0107695
Nov. 8, 2019 (KR) 10-2019-0142969
Jun. 4, 2020 (KR) 10-2020-0067483
Jun. 17, 2020 (KR) 10-2020-0073497

(51) Int. Cl. H04B 7/06; H04W 72/12; H04L 1/18

(52) U.S. Cl. CPC H04B 7/0639; H04W 72/1278; H04L 1/1812

(57) ABSTRACT

An operation method of a source terminal for sidelink communication comprises transmitting at least two transport blocks (TBs) or code block groups (CBGs) to a destination terminal, and receiving hybrid automatic repeat request-acknowledgement/negative acknowledgement (HARQ-ACK/NACK) bits for the at least two TBs or CBGs from the destination terminal. The operation method further comprises generating an HARQ codebook based on the HARQ-ACK/NACK bits, and reporting the generated HARQ codebook to a serving base station.

### CROSS-REFERENCE TO RELATED APPLICATIONS

This application is a continuation of U.S. application Ser. No. 16/918,767, filed on Jul. 1, 2020, which claims priority to Korean Patent Applications No. 10-2019-0079958 filed on Jul. 3, 2019, No. 10-2019-0084050 filed on Jul. 11, 2019, No. 10-2019-0086617 filed on Jul. 17, 2019, No. 10-2019-0107695 filed on Aug. 30, 2019, No. 10-2019-0142969 filed on Nov. 8, 2019, No. 10-2020-0067483 filed on Jun. 4, 2020, and No. 10-2020-0073497 filed on Jun. 17, 2020 with the Korean Intellectual Property Office (KIPO), the entire contents of which are hereby incorporated by reference.

### BACKGROUND

### 1. Technical Field

The present disclosure relates generally to methods and apparatuses for sidelink communication, and more specifically, to a feedback method, an operation method according to semi-persistent scheduling (SPS), a pre-emption method, and an operation method of a relay terminal for sidelink communication, and apparatuses therefor.

### 2. Related Art

The communication system (hereinafter, a new radio (NR) communication system) using a higher frequency band (e.g., a frequency band of 6 GHz or higher) than a frequency band (e.g., a frequency band lower below 6 GHz) of the long term evolution (LTE) (or, LTE-A) is being considered for processing of soaring wireless data. The NR communication system may support not only a frequency band below 6 GHz but also 6 GHz or higher frequency band, and may support various communication services and scenarios as compared to the LTE communication system. In addition, requirements of the NR communication system may include enhanced mobile broadband (eMBB), ultra-reliable low-latency communication (URLLC), massive machine type communication (mMTC), and the like.

Sidelink communication may be performed in the NR system. In order to improve the performance of sidelink communication, transmission of feedback information (e.g., acknowledgment (ACK) or negative ACK (NACK)) for sidelink data may be performed. For example, a first terminal may transmit data to a second terminal, and the second terminal may transmit feedback information for the data to the first terminal. Meanwhile, the sidelink communication may be performed based on a unicast scheme as well as a broadcast scheme or a groupcast scheme.

### SUMMARY

Accordingly, exemplary embodiments of the present disclosure provide an operation method of a transmitting terminal (i.e., source terminal or source user equipment (SUE)) for sidelink communication.

Accordingly, exemplary embodiments of the present disclosure provide an operation method of a receiving terminal (i.e., destination terminal or destination user equipment (DUE)) for sidelink communication.

Accordingly, exemplary embodiments of the present disclosure provide an operation method of a serving base station for sidelink communication.

According to an exemplary embodiment of the present disclosure, an operation method of a source terminal for sidelink communication may comprise transmitting at least two transport blocks (TBs) or code block groups (CBGs) to a destination terminal; receiving hybrid automatic repeat request-acknowledgement/negative acknowledgement (HARQ-ACK/NACK) bits for the at least two TBs or CBGs from the destination terminal; generating an HARQ codebook based on the HARQ-ACK/NACK bits; and reporting the generated HARQ codebook to a serving base station.

The HARQ codebook may be reported to the serving base station through a physical uplink control channel (PUCCH), or reported to the serving base station through a physical uplink shared channel (PUSCH) as multiplexed with an uplink shared channel (UL-SCH).

The HARQ-ACK/NACK bits may be respectively received from the destination terminal through physical sidelink feedback channels (PSFCHs), or received from the destination terminal as multiplexed in one PSFCH.

The HARQ-ACK/NACK bits may be received from the destination terminal in form of an HARQ codebook.

Information on a number of the TBs or the CBGs reported through the HARQ codebook may be received from the serving base station through downlink control information (DCI).

The HARQ-ACK/NACK bits may be arranged in the HARQ codebook according to an order in which the source terminal receives the HARQ-ACK/NACK bits or an order in which the source terminal receives DCIs corresponding to the TBs or the CBGs from the serving base station.

The HARQ codebook may further include HARQ-ACK/NACK bit(s) for downlink shared channel(s) (DL-SCH(s)) received by the source terminal from the serving base station.

According to an exemplary embodiment of the present disclosure, an operation method of a destination terminal for sidelink communication may comprise receiving at least two transport blocks (TBs) or code block groups (CBGs) from a source terminal; and transmitting hybrid automatic repeat request-acknowledgement/negative acknowledgement (HARQ-ACK/NACK) bits for the at least two TBs or CBGs to the source terminal.

The HARQ-ACK/NACK bits may be respectively transmitted through physical sidelink feedback channels (PSFCHs), or transmitted as multiplexed in one PSFCH.

The one PSFCH may be selected among two or more PSFCHs with overlapping time resources.

The HARQ-ACK/NACK bits may be transmitted through a PSFCH in form of an HARQ codebook.

The HARQ-ACK/NACK bits may be arranged in the HARQ codebook according to an order in which the destination terminal receives the TBs or the CBGs.

According to an exemplary embodiment of the present disclosure, an operation method of a serving base station for sidelink communication may comprise configuring, to a source terminal, transmission of at least two transport blocks (TBs) or code block groups (CBGs) for a destination terminal; and receiving, from the source terminal, a report of hybrid automatic repeat request-acknowledgement/negative acknowledgement (HARQ-ACK/NACK) bits for the at least two TBs or CBGs that the source terminal receives from the destination terminal.

The HARQ codebook may be reported through a physical uplink control channel (PUCCH), or reported through a physical uplink shared channel (PUSCH) as multiplexed with an uplink shared channel (UL-SCH).

The HARQ-ACK/NACK bits may be respectively received by the source terminal from the destination terminal on physical sidelink feedback channels (PSFCHs), or received by the source terminal from the destination terminal as multiplexed in one PSFCH.

The one PSFCH may be selected among two or more PSFCHs with overlapping time resources.

The source terminal may receive the HARQ-ACK/NACK bits from the destination terminal through a PSFCH in form of an HARQ codebook.

The operation method may further comprise indicating to the source terminal information on a number of the TBs or the CBGs reported through the HARQ codebook by using downlink control information (DCI).

The HARQ-ACK/NACK bits may be arranged in the HARQ codebook according to an order in which the source terminal receives the HARQ-ACK/NACK bits or an order in which the source terminal receives DCIs corresponding to the TBs or the CBGs from the serving base station.

The HARQ codebook may further include HARQ-ACK/NACK bit(s) for downlink shared channel(s) (DL-SCH(s)) transmitted by the serving base station to the source terminal.

Using the methods and apparatuses for sidelink communication according to the exemplary embodiments of the present disclosure as described above, the sidelink communication can be performed more efficiently. Therefore, the performance of the communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIGS. 3 to 5 are conceptual diagrams for explaining scenarios in which two SL SPSs are activated to support V2X traffic.

FIG. 6 is a sequence chart illustrating an SL transmission/reception procedure between SUE, DUE, and RUE according to an exemplary embodiment of the present disclosure.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. However, the communication systems to which exemplary embodiments according to the present disclosure are applied are not restricted to what will be described below. That is, the exemplary embodiments according to the present disclosure may be applied to various communication systems. Here, the term ‘communication system’ may be used in the same sense as the term ‘communication network’.

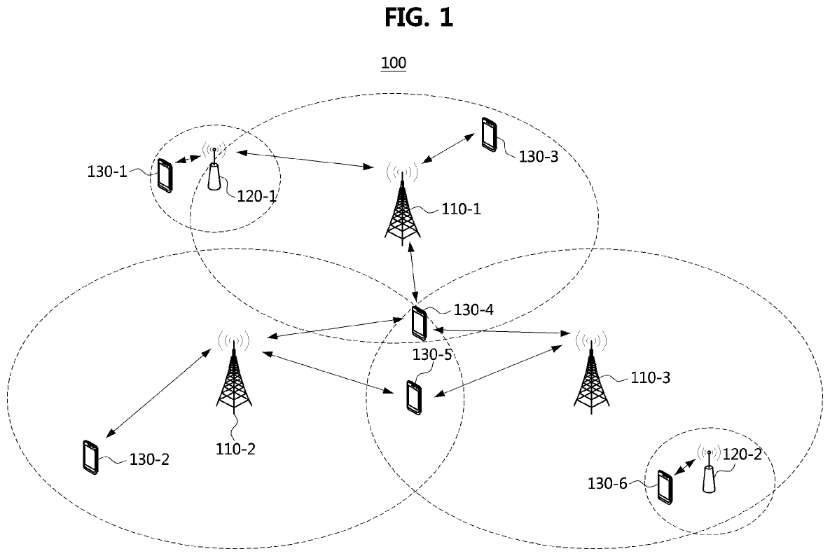

FIG. 1 is a conceptual diagram illustrating a first exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

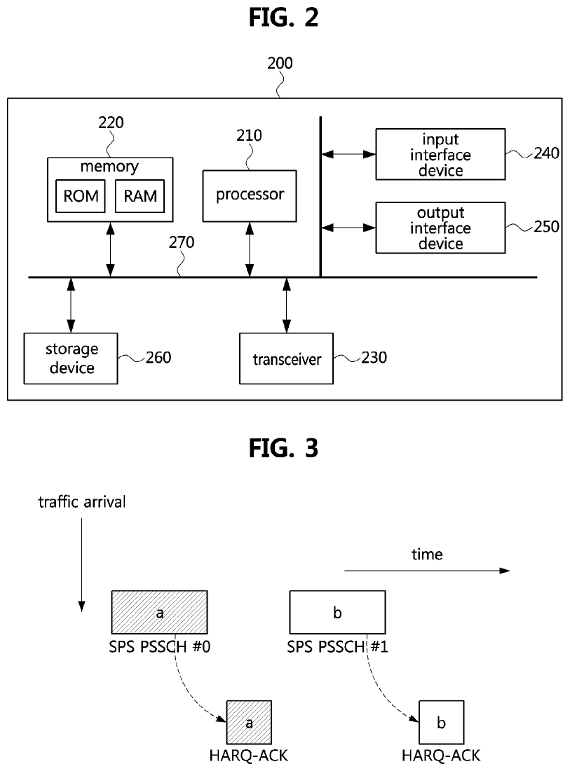

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

In the LTE communication system or the NR communication system, V2X services may be provided through a PC5 interface and/or a Uu interface. In particular, the PC5 interface uses V2X sidelink (SL) communication. The V2X SL communication may be supported by an out-of-coverage terminal (i.e., user equipment (UE)) as well as an in-coverage terminal belonging to coverage of a base station. Resource allocation for the V2X SL communication may be performed in two operation modes.

In the first mode (i.e., mode 1), when an RRC connection is established between a terminal and a serving base station (i.e., when the terminal is in the RRC_CONNECTED state), the terminal may request a resource for SL communication from the serving base station, and the serving base station may allocate a resource(s) to the terminal. The second mode (i.e., mode 2) is a scheme in which the terminal autonomously secures a resource(s) for SL communication. The second mode may be applied when a resource pool is configured to the terminal. The terminal operating in the second mode may sense a SL resource(s) and may select or reselect a specific resource according to a result of the sensing. In this case, multiple SL resources may be reserved. The number of resources that the terminal can reserve at the same time may be limited. In addition, the terminal may perform SL transmission in one resource among a plurality of reserved resources. One terminal may assist SL resource selection of another terminal, or may directly allocate a resource(s) to another terminal.

Meanwhile, the terminal may report its geographic location information to the serving base station, and a mapping relationship between the reported geographic location and a SL resource pool may be indicated to the terminal through higher layer signaling from the serving base station. Such the mapping relationship may be utilized in the mode (i.e., mode 2) in which the terminal can select SL resources. A preconfigured mapping relationship may be applied to a terminal that does not belong to the coverage of the base station. The terminal may support SL transmission in multiple carriers or in multiple operators' networks (i.e., public land mobile networks (PLMNs)).

The terminal may be configured with multiple SL semi-persistent scheduling (SPS), and one or more SL SPSs among the configured SL SPSs may be activated. The activation and deactivation of the SL SPS may be indicated through a downlink control channel (i.e., physical downlink control channel (PDCCH)) of the serving base station. The terminal may provide terminal assistance information (hereinafter, ‘UE assistance information’) to the serving base station. A scheme by which the terminal provides the UE assistance information to the serving base station may be configured by the serving base station to the terminal through higher layer signaling. The UE assistance information may include information on traffic characteristics (e.g., periodicity of SL SPS, timing offset (configured in units of slots or subframes based on a system frame number (SFN) 0), etc.), a layer 2 (L2) identifier (ID) of a destination terminal of SL transmission, logical channel identification information (e.g., logical channel identifier (LCID)), the maximum size of a transport block derived from a traffic pattern, etc.), and/or the like, and may be utilized by the serving base station when activating the SL SPS.

The SL resource pool may be defined in various frequency regions, and information on the SL resource pool configured in a frequency other than a serving frequency may be broadcast by the serving base station through system information, transmitted to the terminal through dedicated signaling, or preconfigured to the terminal.

A plurality of non-overlapping carriers may be configured by the serving base station to the terminal to which the base station allocates resources. In SL communication, a transmitting terminal (i.e., source UE (hereinafter, ‘SUE’)) may be configured with two or more non-overlapping carriers per a receiving terminal (i.e., destination UE (hereinafter, ‘DUE’)), and these carriers may be utilized for data packet duplication.

When SL transmission and UL transmission overlap in time at the same frequency, the UL transmission may be preferentially performed or the SL transmission may be preferentially performed according to the priorities thereof The priority may be indicated by a higher layer or may be known in advance to the terminal.

In the mode (i.e., mode 1) in which the serving base station allocates SL resources, the serving base station may indicate, to a terminal (i.e., SUE), contents to be included in sidelink control information (SCI) to be transmitted by the SUE to a DUE. The terminal (i.e., SUE) may receive a PDCCH by using a separate radio identifier (i.e., RNTI). Hereinafter, a DCI (i.e., DCI including the contents of the SCI to be transmitted to the DUE) transmitted by the serving base station through a PDCCH to allocate a SL transmission resource(s) to the SUE may be referred to as ‘SL-DCI’. In addition, for convenience of description, a transport block (TB) transmitted through a SL-shared channel (SL-SCH) may be referred to as the ‘SL-SCH’, and a TB transmitted through a downlink-shared channel (DL-SCH) may be referred to as the ‘DL-SCH’, thereby distinguishing the SL transmission and the Uu transmission.

The SL-DCI may include information on a frequency resource and a time resource to which a physical sidelink shared channel (PSSCH) is to be mapped, in order to indicate a resource of the PSSCH that the SUE is to transmit to the DUE. The frequency resource may mean physical resource blocks (PRBs) to which the PSSCH is mapped. Depending on whether or not frequency hopping is applied to the PSSCH, the size or interpretation of a field indicating the frequency resource may vary. The time resource may be a slot to which the PSSCH is mapped and symbols belonging to the slot. The terminal (i.e., SUE) receiving the SL-DCI may indicate the time resource of the PSSCH to the DUE by using a start and length indicator value (SLIV) and K0.

The serving base station may indicate the SUE participating in the SL transmission to report an HARQ-ACK/NACK received from the DUE for the PSCCH transmitted from the SUE to the DUE. The HARQ-ACK/NACK report may be applied when the PSSCH is dynamically allocated according to the conventional technical specification. In an exemplary embodiment of the present disclosure, the HARQ-ACK/NACK report may be applied even when the PSSCH is semi-statically allocated (e.g., configured grant type 1/type 2). That is, the DUE may transmit, to the SUE, a reception result (i.e., HARQ-ACK/NACK) for the PSSCH transmitted from the SUE by using a physical sidelink feedback channel (PSFCH), and the SUE may report, to the serving base station, the HARQ-ACK/NACK received from the DUE by using a PUCCH (or PUSCH). Meanwhile, the SL-DCI may include at least information on a resource index and a time resource to indicate a PUCCH resource for the HARQ-ACK/NACK report. The PUCCH resource may be determined within a PUCCH resource set configured by the serving base station to the SUE through higher layer signaling. More specifically, one PUCCH resource set may be selected according to the amount of UCI included in the PUCCH, and one PUCCH resource may be selected using the resource index indicated by the SL-DCI within the selected PUCCH resource set. The PUCCH resource may include at least a DM-RS resource the PUCCH, and PRB(s) and symbol(s) occupied by the PUCCH, which are used when transmitting the PUCCH.

When a PUSCH is transmitted in a symbol(s) to which the PUCCH is allocated (i.e., when the PUCCH and the PUSCH overlap at least partially), the SUE may transmit the PUSCH, and multiplex the UCI (i.e., HARQ-ACK or CSI), which the SUE intends to include in the PUCCH, with a UL-SCH. Alternatively, when a priority of the UL-SCH is higher than that of the UCI (i.e., HARQ-ACK or CSI), the SUE may transmit only the PUSCH without transmitting the PUCCH.

When a large TB is allocated to the SL-SCH, the terminal may (re)transmit the TB on a code block group (CBG) basis to increase efficiency of (re)transmission. The CBG-based (re)transmission may be configured by the serving base station. The DUE may receive CBG transmission information (CBGTI) to identify which CBG is transmitted from the SUE. When the DUE is provided with CBG flushing out information (CBGFI), the DUE may receive the CBGFI, and identify for which CBG an HARQ buffer can be flushed out.

In an exemplary embodiment, the serving base station may indicate to the SUE (re)transmission on a CBG basis by using a SL-DCI. When a SL-SCH is transmitted on the PSSCH, it may be transmitted on a CBG basis. In this case, the CBGTI and/or the CBGFI may be included in the SL-DCI transmitted by the serving base station to the SUE. The CBGTI may indicate to the SUE CBGs to be transmitted on the SL-SCH (or TB), and may be represented by a bitmap.

In an exemplary embodiment, the serving base station may not indicate to the SUE (re)transmission on a CBG basis by using a SL-DCI, and the SUE may indicate to the DUE (re)transmission on a CBG basis by using a SCI. The serving base station may use a SL-DCI to indicate to the SUE only transmission on a TB basis, and may not be involved in the (re)transmission on a CBG basis. The SUE may perform initial transmission and retransmission of a TB on a CBG basis in the reserved resource. When the SL-SCH is transmitted on the PSSCH, the CBGTI and/or the CBGFI may be included in the corresponding SCI. The CBGTI may indicate to the SUE CBGs to be transmitted on the SL-SCH (or TB), and may be represented by a bitmap.

Although the SUE needs to transmit HARQ-ACK/NACK bit(s) (or HARQ codebook) for the SL-SCH to the serving base station, the SUE may still be performing retransmission for some CBGs with respect to the DUE. In this case, since the SUE has not successfully completed transmission of the corresponding SL-SCH to the DUE, the HARQ-ACK/NACK for the corresponding TB may be regarded as NACK.

The DUE may transmit as many HARQ-ACK/NACK bits as the number of CBGs to the DUE on the PSFCH. In this case, when the number of HARQ-ACK/NACK bits is 2 bits or more, the encoded HARQ-ACK/NACK bits may be included in the PSFCH.

Codebook-Based HARO-ACK/NACK Feedback Method

In the codebook-based HARQ-ACK/NACK feedback scheme, a plurality of HARQ-ACK/NACK responses may be collected as an HARQ codebook, and the HARQ codebook may be composed of one or more HARQ-ACK/NACK bits. The HARQ-ACK/NACK bit may be generated for each transport block (TB) or CBG. The HARQ-ACK/NACK may be generated for a PDSCH (i.e., DL-SCH) received by the SUE from the base station or for a PSSCH (i.e., SL-SCH) transmitted by the SUE to the DUE. In order to transmit the generated HARQ responses on a PUCCH (or PUSCH), the SUE may generate an HARQ codebook.

The SUE may generate an HARQ codebook by concatenating HARQ-ACK/NACK bits for several SL-SCHs. In order to generate the HARQ codebook consisting only of the HARQ-ACK/NACK bits for SL-SCHs, the SUE may need to determine an order in which the HARQ-ACK/NACK bits for the SL-SCHs are arranged. Although the SUE is allocated a resource(s) for one SL-SCH by the SL-DCI, the same SL-SCH may be repeatedly transmitted on the PSSCH according to a transmission type (i.e., unicast, groupcast, or broadcast) of the PSSCH. When the SUE operates based on multiple SL-DCIs, HARQ-ACK/NACK bits for multiple HARQ processes may coexist in the HARQ codebook.

In an exemplary embodiment, the SUE may arrange the HARQ-ACK/NACK bits for the corresponding SL-SCHs in the HARQ codebook in the order in which the corresponding SL-DCIs are received. The SUE may determine the order of SL-SCHs based on the order of the corresponding SL-DCIs received from the serving base station. When operating in multiple SL carriers, initial transmission of a PSSCH for a SL-DCI received earlier may not be earlier than initial transmission of a PSSCH for a SL-DCI received later.

The SUE may transmit PSSCHs in multiple carriers, and these carriers may not be synchronized with each other (e.g., slot indices are not synchronized). The SUE may know in which carrier the PSSCH is transmitted, but the serving base station may not know this. Accordingly, the HARQ-ACK/NACK bits for the corresponding SL-SCHs may be arranged in the HARQ codebook according to the order in which the serving base station transmits the SL-DCIs (i.e., the order in which the SUE receives the SL-DCIs), which is the order that the serving base station can clearly recognize.

In another exemplary embodiment, the SUE may arrange the HARQ-ACK/NACK bits for the corresponding SL-SCHs in the HARQ codebook in the order of initial transmissions for the PSSCHs. The SUE may determine the positions of the HARQ-ACK/NACK bits for the corresponding SL-SCHs within the HARQ codebook in the order in which the SUE transmits the PSSCHs (or, in the order of time resources in which the PSCCHs are initially transmitted, when the PSCCH is repeatedly transmitted several times). When a PSFCH for the PSSCH is configured to be received, the position of the HARQ-ACK/NACK bit for the SL-SCH within the HARQ codebook may be interpreted as determined according to the order in which the SUE receives the PSFCH corresponding to the SL-SCH. When the SL-DCI includes a field indicating an offset of a slot in which the PSSCH is to be transmitted (i.e., because the SL-DCI variably indicates the slot in which the corresponding PSSCH is transmitted), the reception order of the SL-DCI may not be the same as the transmission order of the corresponding PSSCH. Alternatively, when the field indicating the offset of the slot in which the PSSCH is to be transmitted is not included in the SL-DCI, the SUE may transmit the PSSCH in the first slot capable of transmitting the PSSCH. According to configuration of the resource pool(s), the transmission order of the PSSCH and the reception order of the SL-DCI may not necessarily coincide with each other. The DUE(s) may decode the PSSCH transmitted by the SUE, and derive an HARQ-ACK/NACK for the PSSCH. The DUE(s) may respond the derived HARQ-ACK/NACK to the SUE on the PSFCH, or may not transmit the PSFCH according to configuration of the serving base station.

In an exemplary embodiment, the SUE may separately generate the HARQ codebook for the DL-SCH(s) received from the base station and the HARQ codebook for the SL-SCH(s) transmitted to the DUE, and the PUCCH resources for transmitting the HARQ codebooks may also be configured separately.

If the SUE separately generates the HARQ codebook for the DL-SCH(s) and the HARQ codebook for the SL-SCH(s), the HARQ codebooks may be mapped to separate PUCCH resources. It may be preferable that the serving base station indicates to the SUE the PUCCH resource for transmission of the HARQ codebook for the DL-SCH(s) and the PUCCH resource for transmission of the HARQ codebook for the SL-SCH(s) so that they do not overlap in time with each other. Otherwise, the SUE may select one PUCCH resource according to the priorities thereof The serving base station may configure these priorities to the SUE through higher layer signaling.

In another exemplary embodiment, the SUE may generate an HARQ codebook and a PUCCH resource for each service type.

For example, the service type may be classified into eMBB, URLLC, and V2X. Alternatively, the service type may be classified into a Uu interface and a PC5 interface. In the latter case, the service type may be further classified into eMBB in the Uu interface, URLLC in the Uu interface, eMBB in the PC5 interface, and URLLC in the PC5 interface. The service types may be identified by different logical channel headers (LCHs), and may be indicated to the terminal through higher layer signaling. The LCHs may be grouped into logical channel groups (LCGs). In the physical layer, since information on the LCG is not explicitly indicated through dynamic signaling, the SUE may generate an HARQ codebook and determine a PUCCH resource by using implicit information on the LCH or the LCG, or information indicated by higher layer signaling.

Meanwhile, the SUE may identify the service type (or, LCH or LCG) of the PDSCH and the PSSCH by using implicit information or explicit information by higher layer signaling. Here, the implicit information may be represented by a radio identifier by which the DCI (i.e., SL-DCI) is transmitted, a search space to which the DCI (i.e., SL-DCI) is mapped, or a value of a specific field of the DCI (i.e., SL-DCI). Meanwhile, the explicit information may be configured by the base station to the SUE through a radio resource control (RRC) message.

Since an LCG is a set of LCHs having similar traffic characteristics, LCHs belonging to the same LCG should satisfy similar quality error rates and delay times. Therefore, the SUE may generate an HARQ codebook for each LCG or a unit given by higher layer signaling, and map the generated HARQ codebook to the corresponding PUCCH resource. When the PUCCH resource and the PUSCH resource overlap in some symbols, the SUE may transmit only the PUCCH to the serving base station without transmitting the PUSCH, or may transmit the PUSCH in which the HARQ codebook (or CSI) is multiplexed with a UL-SCH to the serving base station.

The eMBB traffic or URLLC traffic composed of only a DL-SCH may be distinguished by a different LCG or higher layer signaling. In this case, the SUE may generate an HARQ codebook for a PDSCH generated from the eMBB traffic and an HARQ codebook for a PDSCH generated from the URLLC traffic. The HARQ codebooks and PUCCH resources corresponding thereto may be different. Similarly, traffic composed of only a SL-SCH may be distinguished by two or more LCGs, and the SUE may generate an HARQ codebook for each LCG or according to an indication of higher layer signaling.

When the SUE receives a DL-SCH and transmits a SL-SCH, some LCHs constituting the DL-SCH and some LCHs constituting the SL-SCH may belong to the same LCG. In this case, the SUE may include an HARQ-ACK/NACK for the DL-SCH and an HARQ-ACK/NACK for the SL-SCH in the same HARQ codebook. In this case, a procedure for locating the HARQ-ACK/NACK for the DL-SCH and the HARQ-ACK/NACK for the SL-SCH in the HARQ codebook may be needed.

In an exemplary embodiment, the SUE may not distinguish the HARQ-ACK/NACK for the DL-SCH and the HARQ-ACK/NACK for the SL-SCH, and may generate the HARQ codebook by applying the same procedure to the HARQ-ACK/NACK for the DL-SCH and the HARQ-ACK/NACK for the SL-SCH.

According to the conventional technical specification, when the terminal generates the HARQ codebook for the DL-SCH, the terminal may generate the HARQ codebook based on a time resource in which the PDSCH including the DL-SCH is received. Accordingly, according to an exemplary embodiment proposed by the present disclosure, the SUE may not distinguish the HARQ-ACK/NACK for the DL-SCH and the HARQ-ACK/NACK for the SL-SCH, and may generate the HARQ codebook based on a time resource to which the PDSCH or the PSSCH is mapped.

As an example, the SUE performing half-duplex communication may not transmit a PSSCH while receiving a PDSCH. Therefore, in this case, HARQ-ACK bits for DL-SCH(s) and HARQ-ACK bits for SL-SCH(s) may be concatenated to form one HARQ codebook, or HARQ-ACK bits for DL-SCH(s) and HARQ-ACK bits for SL-SCH(s) may form HARQ codebooks, separately.

In another example, the SUE performing full-duplex communication may transmit a PSSCH while receiving a PDSCH. Therefore, in this case, according to the conventional technical specification, HARQ-ACK bits for DL-SCH(s) and HARQ-ACK bits for SL-SCH(s) may be located according to time resources of the corresponding PDSCH(s) and/or PSSCH(s). Accordingly, the SUE may sequentially locate HARQ-ACK/NACK bits for physical channels (i.e., PDSCH(s) or PSSCH(s)) starting earlier than the earliest symbol among the last symbols of the physical channels into the HARQ codebook. Thereafter, the physical channel the corresponding position of which has been already determined is not considered later. Even when the DL BWP and SL BWP have different subcarrier spacings and/or CP lengths, they conform to the conventional technical specification.

In another exemplary embodiment, the SUE may separate a procedure of arranging HARQ-ACK/NACK bits for DL-SCH(s) and a procedure of arranging HARQ-ACK/NACK bits for SL-SCH(s), and the SUE may concatenate the HARQ-ACK/NACK bits for DL-SCH(s) and the HARQ-ACK/NACK bits for SL-SCH(s) within one HARQ codebook.

The SUE may generate an HARQ codebook for DL-SCH(s) and an HARQ codebook for SL-SCH(s), respectively, according to the conventional technical specification, and may configure the positions of HARQ-ACK/NACK bits for the DL-SCH(s) to be different from the positions of HARQ-ACK/NACK bits for the SL-SCH(s). More specifically, the SUE may generate the HARQ codebook for the DL-SCH(s) and the HARQ codebook for the SL-SCH(s), respectively, and when they are to be transmitted to the serving base station in the same slot, the SUE may configure one HARQ codebook by concatenating the HARQ codebooks. When the HARQ codebook for the DL-SCH(s) and the HARQ codebook for the SL-SCH(s) need to be transmitted to the serving base station in different slots, the SUE may perform channel coding on each HARQ codebook, and transmit the channel-coded HARQ codebook by mapping it to a PUCCH resource.

The HARQ codebook for the DL-SCH(s) may include, more specifically, a portion in which HARQ-ACK/NACK bits for dynamically indicated DL-SCH(s) are arranged according to a predetermined order, a portion in which HARQ-ACK/NACK bits for semi-statically indicated DL-SCH(s) are arranged according to a predetermined order, a portion in which HARQ-ACK/NACK bits for CBGs of a dynamically indicated DL-SCH are arranged according to a predetermined order, and/or a portion in which HARQ-ACK/NACK bits for CBGs of a semi-statically indicated DL-SCH are arranged according to a predetermined order. All or a part of the portions may be transmitted as included in the HARQ codebook, and the transmitted portions may be concatenated to constitute the HARQ codebook for the DL-SCH(s).

The HARQ codebook for the SL-SCH(s) may include, more specifically, a portion in which HARQ-ACK/NACK bits for dynamically indicated SL-SCH(s) are arranged according to a predetermined order, a portion in which HARQ-ACK/NACK bits for semi-statically indicated SL-SCH(s) are arranged according to a predetermined order, a portion in which HARQ-ACK/NACK bits for CBGs of a dynamically indicated SL-SCH are arranged according to a predetermined order, and/or a portion in which HARQ-ACK/NACK bits for CBGs of a semi-statically indicated SL-SCH are arranged according to a predetermined order. All or a part of the portions may be transmitted as included in the HARQ codebook, and transmitted portions may be concatenated to constitute the HARQ codebook for the SL-SCH(s).

As an example, the SUE performing half-duplex communication or full-duplex communication may determine the order of the HARQ-ACK/NACK bit for the DL-SCH by using a time resource in which the corresponding PDSCH is received and may determine the order of the HARQ-ACK/NACK bit for the SL-SCH by using a time resource in which the corresponding PSSCH is transmitted. In the HARQ codebook, the HARQ-ACK/NACK bits for the DL-SCH(s) and the HARQ-ACK/NACK bits for the SL-SCH(s) may be concatenated.

Accordingly, the SUE may sequentially locate HARQ-ACK/NACK bits for physical channels (i.e., PDSCH(s) or PSSCH(s)) starting earlier than the earliest symbol among the last symbols of the physical channels into the HARQ codebook. Thereafter, the physical channel the corresponding position of which has been already determined is not considered later. When the DL BWP and SL BWP have different subcarrier spacings and/or CP lengths, they conform to the conventional technical specification.

### Exemplary Embodiment 1

The SUE may generate HARQ-ACK/NACK bits for DL-SCH(s) and HARQ-ACK/NACK bits for SL-SCH(s) and transmit them on the same PUCCH.

Meanwhile, when an SPS PDSCH is configured (and activated), the SUE may periodically transmit HARQ-ACK/NACKs for the SPS PDSCH to the serving base station through PUCCHs. The serving base station may indicate to the SUE that the HARQ-ACK/NACK for the SPS PSSCH occurs within 1 bit. That is, the serving base station may indicate transmission of the SPS PSSCH, but may indicate that the number of SL-SCHs processed by the SUE is 1 or less. The SUE may generate an HARQ codebook assuming that HARQ-ACK/NACK for transmission of the SPS PSSCH is 1 bit or less.

When an SPS PSSCH is configured (and activated), the SUE may periodically receive HARQ-ACK/NACKs for the SPS PSSCH from the DUE through PSFCHs, and report the received HARQ-ACK/NACKs to the serving base station through a PUCCH. The serving base station may configure the HARQ-ACK/NACK for the SPS PDSCH and the HARQ-ACK/NACK for the SPS PSSCH to be not transmitted on the same PUCCH. In addition, since the HARQ-ACK/NACK for the SPS PDSCH and the HARQ-ACK/NACK for the SPS PSSCH are not simultaneously reported to the serving base station, the SUE may assume that at most 1 bit for them is included in the HARQ codebook.

### Exemplary Embodiment 2

The SUE may generate an HARQ codebook for DL-SCH(s) and an HARQ codebook for SL-SCH(s), and concatenate them. That is, for the DL-SCH(s), the SUE may arrange HARQ-ACK/NACK bits in the order of the time(s) at which the corresponding PDSCH(s) are received, and concatenate them in the order of serving cells. When necessary, a procedure of concatenating the corresponding HARQ-ACK/NACK bits in the order of CORESETs corresponding to the DL-SCH(s) may be further considered. For the SL-SCH(s), the SUE may arrange HARQ-ACK/NACK bits in the order of the time(s) at which the corresponding PSSCH(s) are received or the order of the time(s) at which the corresponding SL-DCI(s) are received, and concatenate them in the order of serving cells (or serving carriers).

### Exemplary Embodiment 3

The SUE may generate an HARQ codebook for DL-SCH(s) and an HARQ codebook for SL-SCH(s), and transmit them on different PUCCHs. When one or more (e.g., k) SL-DCI based PSSCHs are indicated or an SPS PSSCH is configured (and activated) to the SUE, the SUE may periodically transmit HARQ-ACK/NACK(s) through PUCCH(s). The serving base station may configure HARQ-ACK/NACKs for transmission of the SL-SCH(s) to be generated within k bits in the SUE. The SUE may generate an HARQ codebook by assuming that the HARQ-ACK/NACKs for transmission of the SPS PSSCH are k bits or less.

The HARQ codebook generated by applying the above-described methods has a one-to-one correspondence with a PUCCH resource, and the priority of each HARQ codebook may follow a priority of an LCG of the corresponding DL-SCH and/or SL-SCH or a priority (pre)configured by higher layer signaling. Therefore, since the PUCCH resource also follows the priority of the HARQ codebook transmitted through the corresponding PUCCH resource, when the SUE needs to select only one PUCCH resource, one HARQ codebook (i.e., one LCG) may be selected, and the selected HARQ codebook may be multiplexed in the PUCCH (or PUSCH).

The size of the HARQ codebook included in the PUCCH (or PUSCH) may be indicated by the serving base station. According to the conventional technical specification, the size of the HARQ codebook may be dynamically indicated to the terminal by a DCI (i.e., DL-DCI or UL-DCI) or configured to the terminal by higher layer signaling.

When the serving base station indicates the size of the HARQ codebook by the DCI, according to the conventional technical specification, a specific field of the DCI (e.g., downlink assignment index (DAI)) may indicate an index derived from the number of DL-SCH(s) to the terminal. The terminal may observe a value of the corresponding field to know whether a DCI indicating a PDSCH for which a corresponding HARQ-ACK/NACK bit is included in the HARQ codebook is missed or not, and the amount of UCI that the PUCCH (or PUSCH) should include.

Meanwhile, when an HARQ response is allowed in the SL resource pool in which the SL-SCH is transmitted (i.e., when HARQ feedback is enabled), the DUE may feedback an HARQ-ACK/NACK to the SUE using a PSFCH. The SUE may report the HARQ-ACK/NACK received from the DUE to the serving base station by using a PUCCH.

When the SUE and the DUE perform SL transmission for one SL-SCH, the corresponding HARQ response is represented by one bit. However, since a periodicity of the PSFCH is long (e.g., 2 slots or 4 slots), when multiple SL-SCHs are transmitted during the corresponding period, when multiple PSFCHs are received during a time indicated to transmit a PUCCH, or when carrier aggregation is configured (however, when multiple serving cells are activated in case of an HARQ codebook that is dynamically sized, or when multiple timings for the PSFCH and the PUCCH are configured in case of an HARQ codebook that is semi-statically sized), the HARQ responses may be expressed by several bits.

Since the size of the HARQ responses (i.e., the number of bits) should be known by the DUE to generate the PSFCH, the SUE should be able to indicate the size of the HARQ responses to the DUE (i.e., the size of the HARQ codebook mapped to the PSFCH). When the size of the HARQ codebook in the PSFCH can be fixed to a predetermined number of bits (e.g., 1 or 2 bits), the DUE may need not to receive separate signaling from the SUE.

When the serving base station indicates the resource of the SL transmission to the SUE, the SUE may derive the resources of the PSCCH and PSSCH from the SL-DCI. Since the SUE reports the HARQ response for the PSSCH to the serving base station through a PUCCH, it is preferable that the serving base station indicates the size of the HARQ codebook to be mapped to the PUCCH in the SL-DCI indicating the resources of the PSSCH (and PSCCH).

In the SL transmission, a SL-SCH may be transmitted from the SUE to the DUE in form of unicast or groupcast.

The size of the HARQ codebook may be the number of TBs (or CBGs) corresponding to the HARQ codebook, and in order to express this in a specific field of the SL-DCI, an index derived from the number of TBs (or CBGs) may be defined. According to the conventional technical specification, a counter DAI (cDAI) or a total DAI (tDAI) of the DL-DCI or the UL-DCI may be defined as a remainder value obtained by dividing the number of DL-SCHs by a value that can be expressed by the corresponding field. For example, when the DAI is represented by 2 bits, the DAI may be defined as a remainder obtained by dividing the number of TBs by 4.

In an exemplary embodiment, an index included in the SCI may be defined as a remainder value obtained by dividing the number of SL-SCHs by a value that can be expressed by a specific field of the SCI. This index may be a value required for the DUE to generate the PSFCH.

Meanwhile, the index included in the SL-DCI may be a value needed for generating the PUCCH. A scheme of generating the HARQ codebook may be indicated as a scheme of generating the same HARQ codebook or a scheme of generating different HARQ codebooks according to traffic characteristics (e.g., eMBB and/or URLLC) by e.g., a LCG, a radio identifier, a format of the DCI, a search space to which the DCI is mapped, or a field of the DCI. The HARQ-ACK mapped to the HARQ codebook may be limited to the TB (i.e., DL-SCH(s) (or SL-SCH(s))) using the same method of being transmitted through a physical channel among TBs having traffic of the same/different characteristics. In this case, the size of the HARQ codebook may be given by the number of DL-SCH(s) (or SL-SCH(s)) having the same/different traffic characteristics. According to another method, the HARQ codebook may be identified as the same HARQ codebook when having the same characteristics (e.g., LCG, radio identifier, DCI format, a search space to which the DCI is mapped, or a field of the DCI). In one HARQ codebook generated at this time, HARQ-ACK/NACK bits for the DL-SCH(s) and the SL-SCH(s) may be included in different positions. In this case, the size of the HARQ codebook may be given by the number of TBs (i.e., DL-SCH(s) and SL-SCH(s)) having the same characteristics, and may be independent of the method of being transmitted on a physical channel.

It may be preferable that the serving base station indicates the number of TBs (or CBGs) required for the SUE to transmit the PUCCH (or PUSCH). The number of TBs (or CBGs) may be indicated to the SUE by using a DCI. The HARQ-ACK/NACK bits for DL-SCH(s) and the HARQ-ACK/NACK bits for SL-SCH(s) may be mapped to the same HARQ codebook or different HARQ codebooks in one PUCCH resource. In this case, it is preferable that the DCI indicates the number of TBs.

In an exemplary embodiment, the DCI (i.e., DL-DCI, UL-DCI, or SL-DCI) may include an index derived from the number of TBs (i.e., SL-SCH(s) or DL-SCH(s)).

For example, the DL-DCI or the UL-DCI may indicate an index (i.e., DAI) in which the number of DL-SCH(s) and SL-SCH(s) is reflected. In addition, the SL-DCI may indicate an index (i.e., sidelink assignment index (SAI)) in which the number of DL-SCH(s) and/or SL-SCH(s) is reflected. When different HARQ codebooks are respectively configured for the DL-SCH(s) and the SL-SCH(s), and transmitted on PUCCH(s) or PUSCH(s), only either the number of DL-SCH(s) or the SL-SCH(s) may be reflected to the DAI or the SAI.

When allocating the SL transmission, the SL-SCH may be dynamically allocated by the SL-DCI, but may be semi-persistently allocated. When the SL-SCH is allocated periodically and semi-persistently, a PSSCH resource is not indicated by the SL-DCI. In this case, the DAI (or SAI) should be indicated by reflecting the number of SL-SCH(s) that the SUE has already transmitted in the DCI for the dynamically allocated PDSCH, PUSCH, or PSSCH.

In an exemplary embodiment, the SUE may use a PRI included in the last received DCI (i.e., DL-DCI, SL-DCI, or UL-DCI) in order to derive a PUCCH resource. In the index included in the DCI, both the number of DL-SCH(s) and the number of SL-SCH(s) may be reflected, and only the number of DL-SCH(s) or only the number of SL-SCH(s) may be reflected. That is, by a proposed method, when the number of DL-SCH(s) and the number of SL-SCH(s) are separately reflected, the UL-DCI or the DL-DCI may include the index (i.e., DAI) reflecting the number of DL-SCH(s), and separately the UL-DCI or the SL-DCI may include an index (i.e., SAI) reflecting the number of SL-SCH(s). In this case, the size of the HARQ codebook reported by the SUE to the serving base station may be determined in consideration of both the DAI and the SAI.

According to a proposed method, since the DL-SCH and the SL-SCH are transmitted on different carriers, this may be interpreted as carrier aggregation. In this case, the DCI may further include a total DAI (i.e., tDAI). The total DAI may represent information on the size of the HARQ codebook included in the PUCCH or the PUSCH, and may be represented as an index in which the number of DL-SCH(s) and SL-SCH(s) is reflected or only the number of SL-SCH(s) is reflected.

According to the conventional technical specification, the DUE may or may not feedback an HARQ response based on a geographical distance (i.e., radio distance) between the SUE and the DUE or a reference signal received power (RSRP) of a signal received from the SUE. This may occur in the groupcast SL transmission (i.e., when there is only one SUE, but there are a plurality of specified DUEs). In addition, in the groupcast SL transmission, when there is only one SL-SCH, the DUE may transmit a PSFCH only when an HARQ response corresponding thereto is NACK.

In this case, the SUE should generate an HARQ codebook for the groupcast SL transmission, and report it to the serving base station. However, since some of the DUEs may not transmit the HARQ response, the SUE should also map an HARQ-ACK/NACK bit to a SL-SCH for which some of the DUEs do not transmit the HARQ response.

In an exemplary embodiment, a case where all DUEs do not feedback HARQ responses to the SUE may be expressed as ACK in the HARQ codebook transmitted to the serving base station.

The SUE may determine the case where all DUEs do not feedback HARQ responses as ACK. Therefore, if all DUEs do not feedback the HARQ responses to the SUE, the SUE may indicate ACK for the corresponding TB in the HARQ codebook transmitted to the serving base station.

In another exemplary embodiment, in case that the DUE transmits a PSFCH only in a NACK situation, if at least one DUE transmits NACK, the SUE may indicate 1 bit (i.e., NACK) for the corresponding TB in the HARQ codebook transmitted to the serving base station. That is, when some DUEs feedback NACK to the SUE as the HARQ response, the SUE should retransmit the corresponding SL-SCH. Accordingly, the SUE may indicate NACK for the corresponding TB in the HARQ codebook transmitted to the serving base station.

On the other hand, in the groupcast SL transmission, when the DUE receives two or more SL-SCHs, the DUE generates an HARQ-ACK/NACK bit for each SL-SCH, but a case in which they can be transmitted on a PSFCH may be limited to a case when NACK occurs. Therefore, in this case, the DUE may perform a logical AND operation on the HARQ-ACK bits determined for the respective SL-SCHs to compress the HARQ-ACK bits into one HARQ-ACK/NACK bit. Thereafter, when the compressed HARQ-ACK/NACK bit is NACK, the DUE may feedback the HARQ response to the SUE using a PSFCH. Alternatively, the DUE may generate HARQ-ACK/NACK bits for the respective SL-SCHs and include them in transmission of a PSFCH. That is, the DUE may transfer 1 or 2 bits of HARQ-ACK/NACK bit(s) to the SUE on the PSFCH.

The SUE may receive the DCI (e.g., SL-DCI or DL-DCI) from the serving base station, and generate HARQ-ACK/NACK bits for the SL-SCH and the DL-SCH scheduled by the DCI. Such the HARQ-ACK/NACK bits may be mapped to a PUCCH in form of an HARQ codebook. In this case, the SUE may use the DCI that the SUE received last to determine a PUCCH resource. For example, the DCI may include a PUCCH resource index (PRI), and the SUE may use a PUCCH resource indicated by the PRI.

The SUE may support both URLLC service and eMBB service. In this case, what type of traffic the DCI received by the SUE supports may be identified through an LCG, a higher layer signaling, or a dynamic signaling. That is, the SUE may generate an HARQ codebook for each type of traffic, and may transmit the generated HARQ codebook to the serving base station by using the PUCCH resource indicated by the DCI corresponding to the type. When more than two priorities are considered, the SUE may transmit only an HARQ codebook with a higher priority.

Two or more carriers may be used in SL transmission. The SUE may transmit a PSSCH (and PSCCH), and the DUE may receive the PSSCH (and PSCCH) and generate an HARQ-ACK/NACK for the received PSSCH (and PSCCH). The DUE may transmit the generated HARQ-ACK/NACK to the SUE by using a PSFCH. The SUE may generate an HARQ codebook to transmit the PUCCH to the serving base station, but the DUE may generate an HARQ codebook to transmit the PSFCH to the SUE.

In an exemplary embodiment, the DUE may transmit a separate PSFCH for each SL carrier. When PSSCHs are received through multiple SL carriers from one SUE, the DUE may generate an HARQ-ACK/NACK for each PSSCH, and transmit it to the SUE in the corresponding SL BWP. In this case, the HARQ-ACK/NACK for the PSSCH may be generated on a TB basis or a CBG basis.

In a proposed method, when time resources of two or more PSFCHs overlap each other (even when frequency resources thereof are different), the DUE may multiplex them in one SL channel (e.g., PSFCH) to reduce a cubic metric (CM) or a PAPR. Alternatively, although the DUE transmits one PSFCH for one PSSCH, the DUE may generate the HARQ-ACK/NACK on a CBG basis. That is, one PSFCH including two or more HARQ-ACK/NACK bits may be transmitted. In this case, the DUE may generate the HARQ codebook by arranging the HARQ-ACK/NACK bits in the order of the SL carriers. The HARQ codebook may be channel-coded and mapped to the PSFCH.

In a proposed method, even when time resources of two or more PSFCHs do not overlap each other, they may be multiplexed in one SL channel (e.g., PSFCH). This is because, for example, the PSFCH is periodically provided, and two or more PSSCHs may be allocated in one PSFCH period. Here, the DUE may generate the HARQ codebook by arranging the HARQ-ACK/NACK bits for the PSSCHs for which HARQ-ACK/NACKs should be fed back during a predetermined time according to a predetermined order.

In a proposed method, the DUE may arrange the HARQ-ACK/NACK bit(s) for the SL-SCH(s) in the HARQ codebook according to the order in which the corresponding PSSCH(s) are initially received.

Sidelink SPS Operation Method

According to the conventional technical specification, the serving base station may indicate the terminal to perform SPS transmission. Depending on a signaling method, the SPS may be classified into two types. The first type is a scheme in which the serving base station indicates all resources for the SPS transmission through an RRC message. The second type is a scheme in which the serving base station indicates a part of the resources for the SPS transmission through an RRC message and indicates the remaining resources for the SPS transmission through a DCI. A separate radio identifier may be assigned to the DCI for the second type of the SPS transmission.

Even in the case of SL transmission, in order to reduce the burden (e.g., the amount of control channel or a time delay required for transmitting the control channel) of transmitting control information (i.e., SL-DCI or SCI) that allocates a SL-SCH for traffic that occurs periodically or traffic requiring urgent transmission, the serving base station may configure (and activate) a SL SPS to the SUE. .

SL resource pools for supporting the V2X SL communication may be classified into two modes. As described above, in the first mode, the serving base station may allocate SL resources, and in the second mode, the SUE may autonomously allocate SL resources. SL resource pools supporting the two modes may be (pre)configured to be orthogonal (i.e., pre-configuration or configuration). However, the resource pools supporting two modes may not be necessarily orthogonal, and both modes may operate in the same SL resource pool. Since the serving base station knows in advance the SL resource pool operating in the second mode, even when the SUE operates in the first mode, SL resources should be allocated so that interference is minimized to SUEs and DUEs operating in the second mode.

According to the conventional technical specification, the SUE operating in the second mode transmits a separate signal or channel (i.e., reservation signal or reservation channel) for reserving a SL resource before transmitting a PSSCH (and PSCCH) in the corresponding SL resource. The reservation signal or reservation channel indicates to other SUEs that the corresponding SL resource is scheduled to be occupied, and serves to induce other SUEs to use SL resources other than the corresponding SL resource.

The reservation channel or reservation signal (hereinafter collectively referred to as the ‘reservation channel’) may broadcast a time resource (i.e., slot or symbols) and a frequency resource (i.e., sub-channel(s)) to be used for SL transmission to SUEs operating in the second mode in the same SL resource pool. The SUE, which is scheduled to occupy the SL resource, may broadcast a time to occupy the corresponding SL resource to other SUEs in form of an index. The index may mean an offset of the first slot in which the occupation of the corresponding SL resource starts (i.e., an offset from a slot in which the PSSCH and the PSCCH are transmitted). A value that the index may have may be explicitly broadcast, but a (pre)configured value may be used for all SUEs operating in the second mode without additional signaling.

The reservation channel may be transmitted separately, or may be transmitted as a part of a PSSCH (or PSCCH). When the reservation channel is transmitted as a part of a PSSCH (or PSCCH), the reservation channel may indicate a resource(s) of a PSSCH (and PSCCH) to be transmitted in a next time (or to be transmitted after the next time).

Meanwhile, since the resource pool in which the SL SPS transmission is performed is interpreted as a resource pool operating in the first mode, the SUE may not need to transmit a separate reservation channel. However, since SUE(s) operating in the second mode may be present in an arbitrary SL resource(s) within the resource pool operating in the first mode, in order to reduce interferences to the SUE(s) operating in the second mode, it may be preferable that the SUE for which SL SPS transmission is configured (and activated) transmits a reservation signal.

Accordingly, a case in which the SUE operating in the first mode transmits a reservation channel and a case in which the SUE operating in the first mode does not transmit a reservation signal may be distinguished. That is, the SUE may not transmit a reservation channel in the resource pool operating in the first mode, and may transmit a reservation channel in the resource pool operating in the first mode and the second mode. In the resource pool operating only in the second mode, since the corresponding SUE does not perform SL SPS transmission, the SUE may not transmit any channel (e.g., reservation channel and PSSCH or PSCCH).

In an exemplary embodiment, the SUE operating in the first mode may also transmit a reservation channel. That is, the SUE for which SL SPS transmission is configured (and activated) by the serving base station may transmit a reservation channel before transmitting a PSSCH (and PSCCH). Other SUEs decoding the reservation channel may not perform transmission in a SL resource indicated by the reservation channel. On the other hand, since other SUEs may perform a reception operation (i.e., sensing operation) only in the SL resource pool operating in the second mode, the SUE should transmit a reservation channel in the resource pool operating in the second mode.

In an exemplary embodiment, when the SUE operating in the first mode transmits a reservation channel, the SUE may transmit the reservation channel in the resource pool operating in the second mode. Since the SUE knows the (pre)configured resource pool(s), the SUE may know the resource pool for the second mode. The SUE may also know overlapping resources of the resource pool for the first mode and the resource pool for the second mode (i.e., SL resources belonging to an intersection of the two resource pools). Accordingly, the SUE may transmit the reservation channel in a resource where two modes can coexist. In this case, the reservation channel may be transmitted as an independent channel that is not a part of a PSSCH or PSCCH. The independent reservation channel may indicate reservation of a resource for at least PSSCH (and PSCCH), but may not indicate a modulation and coding scheme (MCS), DM-RS resource, etc. of the PSCCH.

When SL SPS transmission is configured (and activated) to the SUE, the resource pool operating in the first mode (i.e., the resource region in which the SL SPS transmission is performed) and the resource pool operating in the second mode may periodically overlap. In particular, there may be the first PSSCH (and PSCCH) and the last PSSCH (and PSCCH) mapped to the resource pool for the second mode. For the first PSSCH (and PSCCH), the SUE should be able to secure a corresponding resource by transmitting a reservation channel. In the SL SPS transmission, since PSSCHs (and PSCCHs) may occur periodically, a reservation channel for reserving resources therefore may be transmitted as a part of the PSSCH (or PSCCH), but a reservation channel for the first PSSCH (and PSCCH) may not be transmitted as a part of the PSCCH (or PSSCH). Therefore, the reservation channel for the first PSSCH (and PSCCH) may be transmitted on an independent PSCCH.

In an exemplary embodiment, the SUE may indicate that there are no reservations or releases of reservations to neighbor SUEs. When a reservation channel is transmitted independently, no SL resources may be reserved by the SUE not transmitting a reservation channel. When a reservation channel is transmitted as a part of the PSCCH (or PSSCH), no SL resources may be reserved by indicating no information in a field of the PSCCH (or PSSCH) where the reservation channel is located or by indicating an invalid value in the corresponding field. On the other hand, a reservation channel may represent that a specific SL resource is not only reserved but also released.

On the other hand, the last PSSCH (and PSCCH) according to the SL SPS transmission may not need to secure a SL resource of a PSCCH (and PSCCH) to be transmitted next. In the SL SPS transmission, a reservation channel for scheduling the last PSSCH (and PSCCH) may be transmitted as a part of the PSSCH (or PSCCH) transmitted immediately before, or may be transmitted on an independent PSCCH.

In an exemplary embodiment, a specific field of the reservation channel may be used to indicate that a SL resource is not reserved. For example, when a specific field of the reservation channel is set to a first value, it may mean that a specific SL resource indicated by the reservation channel is reserved for a specific time (e.g., a predetermined time indicated by the first value). When the specific field of the reservation channel is set to a second value, it may mean that a specific SL resource indicated by the reservation channel is released from the reservation regardless of whether or not the specific resource has been already reserved. When the specific field of the reservation channel is set to a third value, it may mean that a specific SL resource indicated by the reservation channel is not reserved. In the case of the third value, value(s) of other field(s) of the reservation channel may be ignored. Here, the third value may not be necessary. That is, the specific field of the reservation channel may be set to the first value, the second value, or the third value, may be set to only the first value or the second value, or may be set to only the first value or the third value.

The SUEs confirming that the specific field of the reservation channel is set to the second value (or third value) may determine that the corresponding SL resource indicated by the reservation channel is no longer reserved, and use the SL resource for SL transmission. Accordingly, the reservation channel may include a field indicating reservation/release, etc. as well as a field indicating a location of a specific SL resource (i.e., time and frequency resource).

In another exemplary embodiment, instead of using the explicit specific field described above, the SUEs may combine value(s) of the field(s) included in the reservation channel, and identify that the SL resource indicated by the reservation channel is not reserved.

As an example, specific value(s) may be set to the field(s) of the reservation channel to indicate invalid SL resources (i.e., time and frequency resources). As another example, the time resource (e.g., symbol or slot offset, etc.) of the SL resource reserved by the reservation channel may be set to a specific value. If the field(s) of the reservation channel is interpreted to reserve an invalid SL resource, it may be interpreted as implicitly indicating that the reservation channel does not reserve any SL resource. For example, a time resource having a predetermined value may be indicated by the reservation channel.

In another exemplary embodiment, the SUE may not transmit a reservation channel to indicate that no SL resource is reserved. Since the SUEs decoding the reservation channel know the location of the SL resource through which the reservation channel is to be transmitted (i.e., the location of the resource through which the reservation channel indicated by the index described above is to be transmitted), if a reservation channel is not transmitted through the SL resource, the SUEs may interpret that no SL resource is reserved.

According to the conventional technical specification, the activation for the DL SPS transmission may be indicated to the terminal through a DL-DCI, and after receiving the DL-DCI, the terminal may periodically feedback HARQ-ACK/NACKs for periodically-received PDSCHs. When the serving base station receives an HARQ response for the first transmitted PDSCH on a PUCCH (or PUSCH), the serving base station may determine that the activation of the DL SPS transmission has been successfully indicated to the terminal.

According to the conventional technical specification, activation for the UL SPS transmission (e.g., configured grant type 2) may be indicated to the terminal through a UL-DCI. After receiving the corresponding UL-DCI, resources for transmission of PUSCHs may be periodically provided to the terminal, and the serving base station may determine that the activation of the UL SPS transmission has been successfully indicated to the terminal based on the first PUSCH transmitted by the terminal. Meanwhile, even when the resources for transmission of PUSCHs are periodically provided, if there is no UL-SCH to transmit to the serving base station, the terminal may not transmit the PUSCH.

Like the above-described activation DL-DCI for DL SPS transmission or activation UL-DCI for UL SPS transmission, the SUE may need to perform feedback for a SL-DCI that activates SL SPS transmission.

In an exemplary embodiment, after the activation of SL SPS transmission is indicated by the serving base station through a PDCCH, the SUE may transmit a PSSCH, receive a PSFCH for the PSSCH from the DUE, and transmit a PUCCH based on the PSFCH to the serving base station. A slot in which the SUE transmits the PUCCH may be determined as a slot after receiving the PSFCH. The slot in which the PUCCH is transmitted may be indicated by a SL-DCI. That is, when an HARQ-ACK for a SL-SCH transmitted by the SUE can be received from the DUE, the serving base station may determine that the SL SPS transmission has been activated.

In another exemplary embodiment, when the SUE is instructed by the serving base station to activate SL SPS transmission through a PDCCH, the SUE may transmit an HARQ-ACK for the corresponding PDCCH to the serving base station through a PUCCH.

Meanwhile, the DUE may not receive the PSSCH according to the SL SPS from the SUE. In this case, the DUE may not transmit an HARQ-ACK to the SUE on a PSFCH.

In order to support various V2X traffic, a set of two or more SL SPSs may be activated. Since the V2X traffic may have a periodicity and may have a jitter in some cases, the V2X traffic can be delivered to the SUE/DUE by using SPS PSSCHs through activation of multiple SL SPSs.

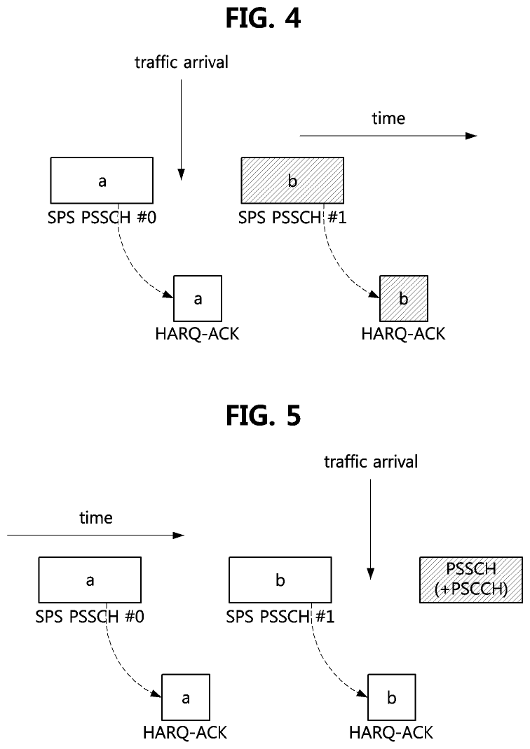

FIGS. 3 to 5 are conceptual diagrams for explaining scenarios in which two SL SPSs are activated to support V2X traffic. In FIGS. 3 to 5, scenarios where two SL SPSs (i.e., configuration ‘a’ and configuration ‘b’) are activated to support one V2X traffic are exemplified.

Referring to FIG. 3, the SUE may transmit V2X traffic to the DUE in an SPS PSSCH #0 according to the SL SPS configuration ‘a’, and the DUE may receive the SPS PSSCH #0 and feedback an HARQ response therefor to the SUE. Since the DUE expects that V2X traffic will not be received in an SPS PSSCH #1 according to the SL SPS configuration ‘b’, the DUE may not need to detect the SPS PSSCH #1, and may not need to feedback an HARQ response therefor to the SUE.

Referring to FIG. 4, the SUE may transmit V2X traffic to the DUE in the SPS PSSCH #1 according to the SL SPS configuration ‘b’. The DUE may attempt to detect the SPS PSSCH #0 according to the SL SPS configured ‘a’. However, since the SUE does not transmit the SPS PSSCH #0, the DUE may feedback NACK to the SUE as an HARQ response to the SPS PSSCH #0, or may not need to feedback the HARQ response. However, since the DUE has not detected the SPS PSSCH #0, the DUE may expect to detect the SPS PSSCH #1. The DUE may detect a DM-RS resource of the SPS PSSCH in order to detect existence of the SPS PSSCH, and may identify whether the corresponding SPS PSSCH exists based on the existence of the DM-RS resource.

Referring to FIG. 5, there is illustrated a case where V2X traffic is out of a time region of the SPS PSSCH #0 according to the SL SPS configuration ‘a’ and the SPS PSSCH #1 according to the SL SPS configuration V. In this case, the SUE may allocate another PSSCH by dynamically scheduling to deliver the V2X traffic to the DUE. The DUE may detect DM-RS resources of the SPS PSSCH #0 and the SPS PSSCH #1, and determine that the SPS PSSCH #0 and the SPS PSSCH #1 have not been transmitted. Accordingly, the DUE may or may not feedback NACK to the SUE as the HARQ response.

In an exemplary embodiment, the SUE or DUE may not derive an HARQ-ACK bit for a disabled SPS PSSCH. According to the conventional technical specification for the Uu interface, an HARQ codebook having a semi-static size may multiplex HARQ responses for all candidates of a DL data channel configured by an RRC message. That is, in the conventional technical specification, a scenario in which one DL SPS is configured to support the eMBB scenario is considered.

However, in order to support the V2X scenario, the SUE and DUE may be configured with multiple SL SPSs in the activated SL BWP through RRC message(s), and some of them may be activated to receive the SPS PSSCH. In this case, in order not to feedback too many HARQ responses, the HARQ responses for some SL SPSs among the SL SPSs may not be fed back. This may mean that the SUE does not feedback the HARQ response to the serving base station through a PUCCH or a PUSCH, and the DUE does not feedback the HARQ response to the SUE through a PSFCH.

When two or more SL SPSs are configured (and activated), resources that the serving base station or the SUE have in multiple PSSCHs may be similar. For example, referring to the case illustrated in FIG. 3, two PSSCHs (i.e., SPS PSSCH #0 and SPS PSSCH #1) have the same periodicity and may support TBs of the same size. However, different slot offsets may be applied to the two PSSCHs (i.e., SPS PSSCH #0 and SPS PSSCH #1).

In this case, these SL SPSs may be interpreted as a set, and two or more SL SPSs may be activated and/or released together through one indicator. For convenience, the SL SPSs that are activated or released together may be referred to as a set of SL SPSs (i.e., ‘SL SPS set’).

Referring to the case of FIG. 3, two SL SPSs may constitute one SL SPS set. The DUE may transmit two HARQ-ACK/NACK bits for each SL SPS to the SUE on a PSFCH, and may transmit one HARQ-ACK/NACK bit for each SL SPS set to the SUE on a PSFCH. Similarly, the SUE may report an HARQ response of up to 1 bit (or up to 2 bits when an SPS PSSCH is composed of 2 codewords) for the SL SPS set to the serving base station through a PUCCH. If the V2X traffic has a larger range of jitter, a DL SPS set may be configured with a larger number of DL SPSs, and if an HARQ response of up to 1 bit (or up to 2 bits when the SPS PSSCH is composed of 2 codewords) may be fed back by the SUE or DUE.

When the HARQ response is generated for each SL SPS set, the position of the HARQ-ACK/NACK bit in the HARQ codebook of the SUE may not actually depend on the time resource in which the SPS PSSCH is received. The reason is that the SUE may not transmit the SPS PSSCH. Therefore, in the HARQ codebook of the SUE, the HARQ-ACK bit for the SL SPS set may be mapped to a position that is a predetermined reference. For example, the position of the HARQ-ACK/NACK bit in the HARQ codebook of the SUE may be determined based on symbols of the SPS PSSCH of the first SL SPS or the last SL SPS belonging to the SL SPS set. However, when the HARQ codebook for all the SL SPSs belonging to the SL SPS set is not received through the PSFCH, the SUE should map NACK to the HARQ codebook reported to the serving base station.

In an exemplary embodiment, the SUE may generate an HARQ codebook with HARQ-ACK/NACK bits for dynamically/semi-statically allocated DL data channels, and then generate the entire HARQ codebook by concatenating HARQ-ACK/NACK bits for the SPS PSSCH (i.e., SL SPS set) into the HARQ codebook. If the HARQ response for the SPS PSSCH does not exist, the size of the entire HARQ codebook generated by the SUE may be reduced by the corresponding amount. The serving base station may predict the size of the entire HARQ codebook in two values. However, since the serving base station allocates the SPS PSSCH, the size of the entire HARQ codebook may be implemented to be interpreted as one size.

The SUE may report the HARQ-ACK/NACK for the SPS PSSCH to the serving base station through a PUCCH. According to the conventional technical specification, a case in which a periodic PUCCH cannot be transmitted may occur depending on the format of the slot. This is because the SPS PSSCH is periodically transmitted on given resources, and the HARQ-ACK corresponding thereto is periodically transmitted on the given resources. In this case, the PUCCH may not be transmitted depending on the format of the slot. For example, the PUCCH may not be transmitted in a DL symbol. On the other hand, when a semi-static flexible (FL) symbol is converted to a dynamic UL symbol, the PUCCH may be transmitted in the corresponding UL symbol.

In an exemplary embodiment, the HARQ-ACK/NACK report timing of the SUE for the serving base station may be changed, and when the PUCCH transmission becomes possible, the HARQ-ACK/NACK report may be transmitted. For example, the SUE may not be able to transmit the HARQ-ACK for the SPS PSSCH(s) through the PUCCH, and this case may occur continuously (k times or more, k≥1, e.g., k=2). Since the SUE cannot transmit the PUCCH, the HARQ-ACK/NACKs for the SPS PSSCH(s) or HARQ codebook may not be transmitted to the serving base station. In the (k+1)-th PUCCH in which the HARQ codebook for the SPS PDSCH(s) is transmitted, the HARQ codebook may be configured by multiplexing k HARQ-ACK/NACKs not transmitted as well as the HARQ-ACK/NACK for the most recent SPS PDSCH(s), and reported to the serving base station. Accordingly, the size of the HARQ codebook transmitted by the SUE to the serving base station may vary according to the format of the slot.

However, the number of HARQ-ACK/NACK bits may be interpreted differently according to a case in which the SUE does not receive a dynamically transmitted slot format indicator (SFI). In addition, in case of the SPS PSSCH configured to support V2X traffic, it is preferable that the timing for transmitting the PUCCH is not changed.

In another exemplary embodiment, when a resource of the PUCCH is not secured, with respect to an HARQ-ACK/NACK to be included in the corresponding PUCCH, the SUE may omit the corresponding transmission of the SPS PSSCH. Depending on the implementation, the DUE may not perform decoding on the corresponding SPS PSSCH. In order for the serving base station to support V2X traffic in the TDD system, when it is determined that the SUE cannot transmit the PUCCH according to the format of the slot, it may be preferable to use a dynamically-allocated PSSCH rather than the SL SPS.

The serving base station may activate or release the SL SPS to the SUE by using a SL-DCI. According to a proposed method, more than two SL SPSs may be activated or released for a SL SPS set.

The serving base station may configure several SL SPSs to the SUE for a given SL BWP by an RRC message, and transmit a SL-DCI to the SUE to activate or deactivate some of the SL SPSs. Since the SL-DCI is scrambled with a specific radio identifier, the SUE may interpret the corresponding SL-DCI as an indication to activate the SPS PSSCH or release the activated SPS PSSCH, not a DCI to dynamically allocate the PSSCH.

According to the conventional technical specification (e.g., NR) supporting the Uu interface, a DL SPS may be configured in a DL BWP, and it is activated or deactivated. Since the DL-DCI (e.g., DCI format 1_0 or format 1_1) used for this case indicates one DL SPS, a separate index is unnecessary. However, when activating two or more DL SPSs in a given DL BWP, the DL-DCI should be able to indicate which DL SPS to activate or deactivate. To this end, a specific field of the DL-DCI may designate one or more DL SPSs.

In an exemplary embodiment, index(es) of one or more SL SPSs may be indicated by a specific field of the SL-DCI. When the specific field includes one index, the length of the field required in the SL-DCI may be determined based on the number of bits required to represent the index. Since the serving base station knows the length of the corresponding field of the SL-DCI according to the number of SL SPS(s) configured in the given SL BWP, the serving station may reflect this in an RRC message that configures the SUE to receive the SL-DCI.

In an exemplary embodiment, index(es) of one or more SL SPS(s) may be indicated by a specific field of the SL-DCI. As described above, the length of the specific field follows the number of configured SL SPS(s), and the serving base station may reflect this in an RRC message that configures the terminal to receive the SL-DCI.

In an exemplary embodiment, the SL-DCI may activate or deactivate two or more SL SPS(s), as well as activate or deactivate one SL SPS. To support this, one index or one bit belonging to a bitmap may indicate two or more SL SPS(s). For convenience of description, two or more SL SPS(s) may be expressed as a SL SPS set, and the SL SPS set may be a set composed of SL SPSs. For each of the SL SPSs belonging to the same SL SPS set, the periodicity of the SPS PSSCH, the resource index of the UL control channel to be used for the HARQ response that the SUE transmits to the serving base station, the MCS table, the number of HARQ processes, and the like may be configured. However, they may be activated or deactivated by one DCI.

Meanwhile, the SL-DCI may switch a SL BWP (e.g., SL BWP 1) while activating the SL SPS. In this case, the index field or bitmap field of the SL SPS included in the SL-DCI may be applied to a SL BWP (e.g., SL BWP 2) which is a switched SL BWP from the SL BWP 1. Accordingly, the number of SL SPSs to be activated or the number of SL SPSs to be activated indicated by the SL SPS set may be different in the current SL BWP 1 and the SL BWP 2 which the switched SL BWP from the SL BWP 1. The SUE may interpret such the case as activation or release of the SL SPS(s) in the SL BWP 2. The index field or bitmap field of SL SPS(s) included in the SL-DCI of the SL BWP may be changed. For example, if the field length in the SL BWP 1 is shorter than the field length in the SL BWP 2, the SUE may add ‘0’(s) or ‘1’(s) to the MSB or LSB of the field value in the SL BWP 1, thereby matching the field length of the SL BWP 1 with the field length of the SL BWP and interpreting this as activation of the SL SPS(s). For example, if the field length of the SL BWP 1 is longer than that of the SL BWP 2, the SUE may delete the MSB or LSB from the field of the SL BWP 1, thereby matching the field length of SL BWP 1 with the field length of SL BWP 2 and interpreting this as activation of SL SPS(s) in the SL BWP 2.

In an exemplary embodiment, the SUE may feedback the HARQ response to all or a part of the SPS PSSCHs belonging to the activated DL SPS to the serving base station. Here, the part of the SPS PSSCHs may be limited to actually-transmitted SPS PSSCHs. For example, in order to support V2X traffic, the serving base station may configure (and activate) a SL SPS having a periodicity of 2 ms to the SUE/DUE, but may configure a PUCCH having a periodicity of 6 ms to the SUE. The DUE may generate an HARQ-ACK/NACK in a every time resource in which the SPS PSSCH is received and feedback it to the SUE by using a PSFCH, but the SUE may transmit a PUCCH including 3 bits of HARQ-ACK/NACK bits to the serving base station.

However, in the above case (i.e., when multiple SPS PSSCHs are configured (and activated) to support V2X traffic), the SUE may generate HARQ-ACK/NACK bits of 3 bits or less. This is because the DUE/SUE generate multiple HARQ-ACK/NACK bits when multiple SPS PSSCHs are configured (and activated), even though the SUE actually transmits one SL-SCH to the DUE.

In an exemplary embodiment, HARQ-ACK/NACKs for multiple SPS PSSCHs may be given as one bit. That is, by performing an OR operation on HARQ-ACK/NACK bits for multiple SPS PSSCHs (i.e., when ACK is determined even for only one SPS PSSCH among the multiple SPS PSSCHs), the DUE may deliver an HARQ-ACK to the SUE. Alternatively, the DUE may transmit HARQ-ACK/NACK bits for multiple SPS PSSCHs to the SUE, and the SUE may perform an OR operation on them to report one HARQ-ACK to the serving base station.

In an exemplary embodiment, the SUE may report all of the HARQ responses described above to the serving base station, but some may not be reported to the serving base station.

When the DUE determines that the SPS PSSCH does not exist, the DUE may not transmit the HARQ response to the SUE. Accordingly, when the HARQ response is fed back to the serving base station through a PUCCH only for the actually-transmitted SPS PSSCH, the HARQ-ACK/NACK bit(s) of 1 bit (or 2 bits when two TBs are present) may be transmitted to the serving base station. In this case, when it is determined that the SPS PSSCH does not exist, the SUE may not transmit the PUCCH to the serving base station, or the SUE may report NACK to the serving base station.

Since the serving base station allocates SL SPS resources, the SUE may receive the HARQ response according to the transmission of the SL-SCH from the DUE through a PSFCH, and report it to the serving base station by using a PUCCH. The time resource for reporting the HARQ response at this time may be derived based on the periodicity of the PSSCH (and the periodicity of the time resource in which the PSFCH can be transmitted), and the PUCCH may be periodically reported to the serving base station. The PSFCH resource in which DUE can use may exist only in a predetermined time region, and may periodically occur every L slots (L=1, 2, or 4) for the DUE. Among them, a PSFCH through which the HARQ response for the PSSCH is transmitted may be determined.

Therefore, the periodicity of the PSSCH and the periodicity of the PSFCH may be different. The PSSCH may be configured (and activated) according to the periodicity of the SL traffic, but since the PSFCH can be transmitted only in a specific slot, the slot offsets of the PSSCH and the PSFCH may be slightly different. Therefore, it may be preferable to determine a minimum time required for the DUE to decode the SL-SCH, and the DUE may preferably feedback the HARQ-ACK response to the SUE in the first PSFCH that occurs after the minimum time.

Meanwhile, since the PSSCH is defined in the SL BWP and the PUCCH is defined in the UL BWP, their OFDM parameters (i.e., CP length, subcarrier spacing, bandwidth, etc.) may be different. Therefore, the HARQ response to the PSSCH transmitted periodically is transmitted through the PSFCH every time, but the periodicity of the PSSCH may be different from the periodicity of the PUCCH.

According to the conventional technical specification, when the DL SPS is configured (and activated), the DL BWP of the PDSCH and the UL BWP of the PUCCH may be different, but the lengths of the slots of the DL BWP and UL BWP may be different while indicating the timing of the HARQ response. However, a method of interpreting the indicated slot index may be defined in the technical specification so that the PDSCH and the PUCCH has one-to-one correspondence, and accordingly, a time interval between the PDSCHs and a time interval between the PUCCHs may have one constant value according to the indicated index.

However, when the PSSCH is periodically transmitted, the PSSCH may not need to correspond to the PUCCH in one-to-one manner. In some cases, it may be preferable for multiple PSSCHs to correspond to one PUCCH. In particular, in the case of SL traffic having characteristics that it should be urgently supported, the SL SPS may be configured (and activated) in order to save a time required for a procedure for the SUE to be allocated resources from the serving base station. In this case, since the corresponding SL traffic does not necessarily occur periodically, the SL-SCH may not necessarily occur in each period of the SL SPS.

In addition, in the case of SL traffic that is frequently generated but need not be urgently supported, the SUE may report the PUCCH excessively frequently to the serving base station. In this case, the serving base station may allow the SUE and the DUE to preform (re)transmission by using the SL SPS (without reporting to the serving base station). Here, the SL-SCH may mean a TB or a CBG that can be transmitted on the PSSCH.

In an exemplary embodiment, the SUE may perform (re)transmission of the PSSCH transmitted according to the SL SPS by using the resources of the PSSCH allocated by the SL SPS. When the SL-SCH is transmitted in the SL SPS resource allocated to the SUE, the SUE may select one SL-SCH among initial transmission SL-SCH(s) and retransmission SL-SCH(s), and map the selected SL-SCH to the PSSCH. For the SL-SCH that is not selected, the SUE may request a resource for transmitting the PSSCH by transmitting an SR to the serving base station through a PUCCH.

When there is no initial transmission SL-SCH, the SUE may select a retransmission SL-SCH, and conversely, when there is no retransmission SL-SCH, the SUE may select an initial transmission SL-SCH. If the higher layer indicates that there is no SL-SCH (i.e., if SL-SCH is not delivered from the higher layer), the SUE may not transmit a PSSCH.

When mapping the retransmission SL-SCH to the PSSCH, the SUE may indicate to the DUE that the retransmission SL-SCH is to be transmitted using PSCCH (i.e., SCI) (e.g., by using NDI, HPID, RV, and/or MCS). As described above, in case that the configured (and activated) periodicity of the SL SPS and the periodicity of generating the SL-SCH are not always the same, the SUE can retransmit the SL-SCH by using the SL SPS resource, so that the HARQ-ACK response to the serving base station may not be fed back every time.

In an exemplary embodiment, the periodicity of the PUCCH may be set to an integer multiple of the periodicity of the PSSCH (and the periodicity of time resources in which the PSFCH can be transmitted).

When the periodicity of the PSSCH and the periodicity of the PUCCH are the same, the SUE may report a PUCCH including one HARQ-ACK/NACK bit to the serving base station. For example, if two or less bits can be transmitted in a specific format of the PUCCH, the SL SPS may be configured (and activated) with a periodicity of transmitting the SL-SCH twice by exploiting 2 bits. If a different format of the PUCCH is used, HARQ-ACK/NACK bits for a larger number of SL-SCHs may be configured as an HARQ codebook, and reported to the serving base station.

In the first type of SL SPS, the serving base station may indicate such an integer value to the terminal through an RRC message. In the second type of SL SPS, the serving base station may indicate such an integer value to the terminal through an RRC message or a SL-DCI.

Depending on the configuration, PSFCH resources may not be allocated to the SL resource pool. However, since the HARQ response is information needed to determine whether to retransmit the SL-SCH, it may be preferable to feedback the HARQ response to the SUE by using a channel (i.e., PSSCH) other than the PSFCH even in the SL resource pool to which the PSFCH resources are not allocated.

In an exemplary embodiment, the HARQ response for the SL transmission may be multiplexed with a SL-SCH, and transmitted on a PSSCH.

The SL transmission is performed by the SUE and the DUE in a given SL resource pool. The roles of the SUE and the DUE in the SL resource pool may be reversed. For example, there are two SL transmissions (i.e., SL transmission of SUE and DUE, SL transmission of sUE and dUE) defined in the same SL resource pool, and one terminal operates as the SUE and the dUE, and the other terminal may operate as the DUE and the sUE.

In an exemplary embodiment, an HARQ codebook derived from the SL transmission of the SUE and the DUE may be fed back in the SL transmission of the sUE and the dUE.

Since PSFCH resources are not allocated to the given SL resource pool, the DUE cannot feedback to the SUE even when the HARQ codebook is generated. Therefore, the DUE may operate as a SUE (i.e., sUE) in the other SL transmission, and transmit the HARQ codebook to the dUE (i.e., SUE).

The HARQ codebook may be multiplexed in a PSSCH. Even when there is no UL-SCH, the PSSCH may be configured only with the HARQ codebook. To this end, the SUE may allocate the PSSCH transmitted by the DUE by using a PSCCH.

A method of multiplexing the HARQ codebook in the PSSCH may be performed similarly to the method in which the terminal multiplexes UCI in a PUSCH according to the conventional technical specification. It may be preferable that the HARQ codebook is mapped to a position close to a DM-RS of the PSSCH and is arranged among subcarriers so as to obtain frequency multiplexing.

When the HARQ codebook is multiplexed with the SL-SCH, an MCS applied to the HARQ codebook may be obtained by applying an offset to an MCS indicated by the SCI that the SUE transmits to the DUE. The offset applied here may also be indicated by the SCI that the SUE transmits to the DUE. The offset may be indicated as an index to a list of offsets which are shared by the SUE and the DUE through higher layer signaling.

If the HARQ codebook is not multiplexed with the SL-SCH, the MCS indicated by the SCI that the SUE transmits to the DUE may be applied to the HARQ codebook as it is.

In an exemplary embodiment, the PSCCH transmitted by the SUE to the DUE may allocate resources such that the DUE can transmit the PSSCH including the HARQ codebook.

In this case, a transmission direction of the allocated PSSCH may be indicated by a specific field of the SCI. For example, when the corresponding field has a first value, it may mean that the DUE receives the PSSCH in the allocated resource, and when the corresponding field has a second value, it may mean that the DUE transmits the PSSCH in the allocated resource. The radio resource of the PSSCH (e.g., time resource, frequency resource, DM-RS resource, etc.) may be derived from information included in the SCI.

In an exemplary embodiment, the PSCCH that the SUE transmits to the DUE may indicate whether the DUE multiplexes the HARQ codebook in the PSSCH transmitted by the DUE.

In this case, when a specific field of the SCI has a first value, it may mean that the DUE multiplexes the HARQ codebook in the PSSCH, and when the specific field of the SCI has a second value, it may mean that the DUE does not multiplex the HARQ codebook in the PSSCH. The radio resource of the PSSCH (e.g., time resource, frequency resource, DM-RS resource, etc.) may be derived from information included in the SCI.

SL Pre-Emption Indicator (PI) Transmission Method

In the SL transmission operating in the second mode, since the terminals may not be located within the coverage of the serving base station, if the serving base station transmits a SL PI, it may not be possible to guarantee sufficient reception quality. Therefore, it may be preferable for the SUE to transmit the SL PI. For example, the SL PI may be transmitted to a plurality of unspecified terminal(s) in form of a SCI.

The terminal(s) receiving the SL PI may decode the SL PI to obtain values of fields included in the SL PI. The contents of the SL PI may include not only a resource (i.e., time resource and frequency resource) of a PSSCH that the SUE desires to transmit, but also a priority of the SL-SCH, identification information (e.g., RNTI or a value of a field included in the SCI) of the DUE, and zone-related information. Accordingly, the terminal(s) may perform SL transmission by avoiding the resource of the PSSCH, or perform the SL transmission or cancel the SL transmission by comparing a priority of a SL-SCH to be transmitted by the terminal(s) and the priority of the SL-SCH indicated by the SL PI to transmit the SL.

The reservation channel and the SL PI have a common feature for preventing other terminal(s) from using some SL resources. However, although the reservation channel may not necessarily need to be received, the SL PI is necessarily required to be received. A case that the terminal operating in the half-duplex communication scheme cannot receive the reservation channel (or SL PI) may occur, and thus, there is a need for a method to enable such the terminal to receive the SL PI (or reservation channel). Alternatively, the reservation channel and the SL PI may not be separately distinguished, and the reservation channel may be interpreted as a type of SL PI or, conversely, the SL PI may be interpreted as a type of reservation channel.

A combination of at least one of proposed methods below may be applied. For example, the SL PI should be transmitted before transmission of the PSSCH (i.e., the PSSCH requiring urgent transmission that is the target of the SL PI), but the SL PI may not be transmitted after the transmission of the PSSCH. Conversely, the SL PI should be transmitted after transmission of the PSSCH, but the SL PI may not be transmitted before the transmission of the PSSCH. Alternatively, the SL PI may be always transmitted before and after transmission of the PSSCH.

In an exemplary embodiment, the SL PI may be transmitted before the SUE transmits the PSSCH (i.e., the PSSCH requiring urgent transmission that is the target of the SL PI).

The terminal operating in the second mode may transmit a reservation channel before transmission the PSSCH, so that the position of the SL resource to be used by the terminal is notified to a plurality of unspecified other terminal(s). The other terminal(s) intending to perform SL transmission may select a SL resource other the SL resources indicated by the reservation channels and transmit a PSSCH (and PSCCH).

Therefore, when the SUE transmits the SL PI, it may be preferable that the SL PI is transmitted before other terminal(s) transmit a PSSCH (and PSCCH). Since the terminal(s) receiving the SL PI does not transmit the PSSCH (and PSCCH) in the resource indicated by the SL PI, interferences to the PSSCH (and PSCCH) transmitted by the SUE can be reduced, so that the reception quality of the PSSCH (and PSCCH) at the DUE can be improved.

In another exemplary embodiment, the SUE may transmit the SL PI after transmission of the PSSCH (i.e., the PSSCH requiring urgent transmission that is the target of the SL PI).

The terminal(s) receiving the SL PI transmitted by the SUE after the SUE transmits the PSSCH may determine that a SL-SCH decoded from the PSSCH (and PSCCH) received in a resource overlapped with the SL resource indicated by the SL PI is received with significant interferences. In some cases, since the SUE transmitting the SL PI may give weak interferences to the neighbor terminal(s), the neighbor terminal(s) (e.g., the terminal(s) far from the DUE) may perform successful reception of a PSSCH (and PSCCH) even in the resource overlapped with the SL resource indicated by the SL PI. On the other hand, in the general case, since the priority of the SL-SCH that is for the SL PI is quite high, the SUE may transmit the SL-SCH with a high transmission power. Therefore, it is common that NACK would be generated for the PSSCH received by the terminal(s) close to the DUE. Accordingly, in order to solve the above problem, the SUE may transmit the SL PI after the transmission of the PSSCH.

In case of the reservation channel, it may be preferable for neighbor terminal(s) to decode the reservation channel, whereas in case of the SL PI, there is a difference in that neighbor terminal(s) should try to decode the SL PI. On the other hand, since some terminal(s) may operate in the half-duplex communication scheme, no channel may be received while transmitting a certain channel (i.e., in a symbol or slot through which the certain channel is transmitted). Therefore, a case that the terminal(s) operating in the half-duplex communication scheme cannot receive a reservation channel or SL PI from another terminal may occur. In particular, since the SL PI cannot be decoded, the terminal(s) operating in the half-duplex communication scheme may potentially interfere with the DUE of the SL transmission that is urgently performed.

In a scenario in which the SUE transmits a SL-SCH to the DUE, it may be considered that other terminal(s) adjacent to the DUE operates in the half-duplex communication scheme. In order to allow other terminal(s) to decode the SL PI (or reservation channel), it may be preferable that the SUE repeatedly transmits the SL PI several times in time.

The neighbor terminal(s) may know that the SL-SCH is to be transmitted in the SL resource (i.e., time and frequency resource) indicated by the SL PI by receiving and decoding the SL PI once or more. When the neighbor terminal(s) decode two or more SL PIs, the neighbor terminal(s) may know that the SL-SCH is to be transmitted in a union of SL resource(s) indicated by the SL PIs.

The SL PI may be transmitted without information for allocating a resource for transmitting a SL-SCH on a PSCCH. Therefore, the SL PI (i.e., SCI or PSCCH) may not necessarily need to be multiplexed (e.g., TDMed or FDMed) in the PSSCH in order to be transmitted.

In an exemplary embodiment, time resources of the PSCCH to which the SL PI is mapped may be derived from identification information of the SUE.

The SL PI may be transmitted by being mapped to a PSCCH or another channel. Among resources in which the PSCCH can be transmitted, two or more time resources (i.e., slots or mini-slots) may be selected, but a time resource through which the PSCCH is transmitted may be determined based on information obtained from the identification information (e.g., RNTI) of the SUE.

A case that a certain terminal continuously cannot receive the SL PIs transmitted by the SUE may occur when the corresponding terminal and the SUE accidentally and continuously select the same time resources (e.g., slots or mini-slots). Accordingly, when the time resource is determined based on information such as the identification information of the terminal, a probability that the terminals continuously select the same time resource may be decreased. Since the terminals have different identification information, a probability that a certain terminal cannot receive the SL PIs in all time resources selected by the SUE may be decreased.

The resources in which the SL PI can be transmitted may be (pre)configured as confined to a limited time region of the SL resource pool operating in the second mode. Therefore, in order for the SUE to transmit an urgent SL-SCH, a delay time may be generated because the SUE should wait for a resource pool allowed to transmit the SL PI.

In an exemplary embodiment, the SUE may transmit the SL PI in contiguous time resources (e.g., slots or mini-slots). That is, the SUE may retransmit the SL PI in a time resource subsequent to a time resource in which the SUE initially transmits the SL PI. Therefore, a probability that other terminal(s) operating in the half-duplex communication scheme decodes the SL PI may increase.

If a specific terminal transmits a PSSCH (and PSCCH) in a time resource (e.g., symbol or slot) in which a SL PI should be received, a probability that the corresponding terminal does not transmit a PSSCH (and PSCCH) in a next time resource (e.g., next symbol or next slot) in which the SL PI can be transmitted may be high. Therefore, it may be preferable for the SUE to transmit the SL PI at least two or more times in the contiguous time resources.

Meanwhile, among other terminal(s) adjacent to the SUE, a terminal may be indicated to perform, for example, blind retransmission in which the terminal repeatedly transmit the SL-SCH without receiving a corresponding HARQ response, so that the same SL-SCH is transmitted in contiguous slots (or mini-slots). In this case, if the corresponding terminal operates in the half-duplex communication scheme, since the terminal transmits the PSSCH (and PSCCH) in the contiguous time resources (e.g., slots or mini-slots), the terminal cannot receive the SL PI in the time region of the PSSCH. Therefore, it may be preferable that the SUE can transmit the SL PI even in symbol(s) not allowed for a PSSCH (or PSCCH) in a given slot.

In an exemplary embodiment, the SUE may transmit the SL PI in the last symbol(s) of the slot.

In order for the SUE to transmit the SL PI to other neighbor terminal(s), the SUE may transmit the SL PI in symbols other than symbols where the PSSCH is transmitted as well as the symbols where the PSSCH is transmitted, in a slot where the SL transmission is performed. That is, it may be preferable that SL PI can be transmitted even in symbols located in a front part of the given slot, in which the PSSCH (and PSCCH) can be transmitted, and symbols located in a rear part of the given slot, in which the PSFCH can be transmitted.

The time region in which the PSFCH is transmitted may be composed of the last symbol(s) of the slot, and may be (pre)configured together with the SL resource pool. Also, it may be (pre)configured to the SL resource pool whether the transmission of the PSFCH is allowed or whether the HARQ response is enabled/disabled. When the terminal(s) is (pre)configured to receive the PSFCH, the terminal(s) may perform a reception operation in the corresponding symbols to receive and decode the PSFCH. Therefore, if the SL PI can be transmitted in the corresponding symbols, the terminal(s) may decode not only the PSFCH but also the SL PI.

When the SL PI is transmitted in the last symbol(s) of the slot, the SL PI may be included in the PSCCH or the PSFCH. The SL PI may be channel-coded and may be transmitted in frequency resources belonging to sub-channel(s) by using a small number of symbol(s). For example, the PSCCH or PSFCH may be configured in a PUCCH format 2 supported by the NR technical specification. One or more PRBs may be used in one or two symbols. In addition, additional symbol(s) for AGC may be allocated before the PUCCH format 2, and additional symbol(s) for transmission/reception switching may be allocated after the PUCCH format 2.

The terminal (e.g., SUE operating in the first mode) may be instructed to receive a UL PI and may be instructed to transmit a PSSCH (and/or PSCCH). The terminal may perform transmission of the PSSCH (and/or PSCCH) transmission without canceling regardless of a position of a resource indicated by the UL PI. However, since this may interfere with UL transmission having a higher priority, it may be preferable that the UL PI and the SL transmission have a correlation. Similarly, the terminal may be instructed to receive a SL PI, and may be instructed to transmit a PUSCH (and/or PUCCH, SRS, etc.). The terminal may perform transmission of the PUSCH (and/or PUCCH, SRS, etc.) without cancelling regardless of a location of a resource indicated by the SL PI. However, since this may interfere with SL transmission with a higher priority, it may be preferable that the SL PI and the UL transmission have a correlation.

Before performing the SL transmission or reception, the terminal receiving the UL PI should be able to compare a priority of traffic indicated by the UL PI and that of traffic considered by the SL transmission or reception. When it is determined that the UL PI allocates more important traffic, the terminal may or may not perform the SL transmission or reception depending on the position of the radio resource indicated by the UL PI. On the other hand, when it is determined that the SL transmission or reception considered by the terminal is transmission or reception of more important traffic, the terminal may perform the SL transmission or reception without using the result of decoding the UL PI.

In an exemplary embodiment, the priorities may be implicitly determined.

The priority may be determined according to the type of SL/UL transmission (e.g., unicast, groupcast, or broadcast). As an example, the priorities may be defined in the order of broadcast, groupcast, and unicast. As another example, broadcast and groupcast may have the same priority, and broadcast and groupcast may have a higher priority than that of unicast.

In another exemplary embodiment, the priority of traffic may be explicitly indicated.

The priority of the traffic may be (pre)configured or indicated by physical layer signaling. The priority indicated by using the UL PI (i.e., the priority of traffic targeted by the UL PI) may be indicated to the terminal by using a radio identifier applied to a physical channel (i.e., PDCCH) through which the UL PI is transmitted, or an identifier of a search space of the corresponding physical channel. Alternatively, a specific field of the UL PI may indicate the priority of the UL-SCH/SL-SCH that is a target of the UL PI. Alternatively, a specific field of the PSCCH (e.g., SL PI or SCI) may indicate the priority of the SL-SCH. The terminal may additionally be configured with a prioritization threshold through higher layer signaling, and when it is determined that the traffic has the same priority as or a higher priority than the threshold (e.g., when the traffic is URLLC traffic), the terminal may perform no operation in spite of the SL PI. On the other hand, when it is determined that the traffic has a lower priority than the threshold (e.g., when the traffic is eMBB traffic), the terminal may drop transmission of the PSSCH or PSCCH partially or completely by receiving the UL PI.

In an exemplary embodiment, the terminal receiving the SL PI may transmit a reservation channel (or SCI allocating a PSSCH) again.

When a SPS resource is allocated to the terminal, a reservation channel may be transmitted as a part of a PSCCH (and PSSCH), and the reservation channel may indicate a SL resource of a PSSCH (and PSCCH) to be transmitted next. When the SPS resource reserved for the terminal and a resource indicated by a SL PI received by the terminal partially overlap, the terminal may not transmit the PSSCH (and PSCCH) in the reserved SPS resource. In this case, the SL resource intended to be reserved may not be able to be reserved due to the SL PI. In order for the terminal to (re)transmit the PSSCH after that, the SL resource to be reserved by the terminal should be indicated by using a separate independent PSCCH.

In an exemplary embodiment, when receiving a UL PI, the terminal may not transmit a reservation channel, a PSSCH (and PSCCH), or a PUCCH.

In the communication system for supporting the URLLC scenario, the serving base station may transmit a UL PI to terminals in form of a DCI through a PDCCH. Some terminals decoding the UL-PI may not perform UL transmission (i.e., PUSCH, PUCCH, SRS, or PRACH transmission) in a UL resource indicated by the UL PI. The terminals decoding the UL PI may not perform UL transmission when a priority of the UL transmission is lower than a priority indicated by the UL PI. The terminals decoding the UL PI may perform UL transmission when the priority of the UL transmission is equal to or higher than the priority indicated by the UL PI. Here, each priority of the UL PI and the UL transmission may be given by a radio identifier, an index of a search space, or the like, and may be determined by higher layer signaling of the serving base station.

Meanwhile, the terminal operating in the first mode may perform SL transmission according to a SL-DCI from the serving base station, and may report an HARQ-ACK/NACK for the SL transmission to the serving base station by using a PUCCH. In this case, a priority of the PUCCH may follow a priority of the SL-DCI. Alternatively, the priority of the PUCCH may be determined according to whether or not the highest priority among the priorities of SL-SCHs corresponding to HARQ-ACKs included in the PUCCH exceeds a specific prioritization threshold. Here, the specific prioritization threshold may be indicated by higher layer signaling from the serving base station to the terminal, and when exceeding the prioritization threshold, the traffic may be regarded as important traffic (i.e., URLLC traffic). The terminal receiving the UL PI may compare the priority of the UL-PI and the priority of the SL-DCI, and when the priority of the UL PI is higher than the priority of the SL-DCI, the terminal may not transmit a PUCCH in the UL resource indicated by the UL-PI. Also, the terminal receiving the UL PI may compare the priority of the UL-PI and a priority of a PUCCH, and when the priority of the UL PI is higher than the priority of the UL-PI, the terminal may not transmit the PUCCH in the UL resource indicated by the UL-PI.

When the SL resource pool (or SL BWP), in which the SL-SCH is transmitted, overlaps partially or completely with the UL BWP (when the same subcarrier spacing and cyclic prefix are applied), if the terminal receives the UL PI, the terminal may not transmit a reservation channel, a PSSCH (and PSCCH), or a PUCCH according to the priority (and whether resources are allocated to be overlapped or not).

As an example, when the terminal receives a UL PI even after transmitting a reservation channel, the terminal may not transmit a PSSCH (and PSCCH). As another example, when the terminal receives a UL PI even after transmitting a PSSCH (and PSCCH), the terminal may not transmit a PUCCH. In the case that the terminal does not transmit a channel or a part of the channel by the UL PI, the serving base station may allocate a SL resource to the terminal again.

Since the SL PI may be decoded and information therefrom may be applied after a lapse of a predetermined time (i.e., processing time) from reception of the SL PI, the terminal may not perform the SL transmission (i.e., transmission of the reservation channel, PSSCH, PSCCH, or PUCCH). However, the terminal cannot reflect the SL PI before the lapse of the predetermined time, and thus a part of the SL transmission may be performed as reserved (or as allocated).

When the terminal fails to transmit the PUCCH, the serving base station may transmit a SL-DCI again to instruct the terminal to transmit the PSSCH (and PSCCH). The terminal may receive an HARQ-ACK/NACK through a PSFCH, and report the received HARQ-ACK/NACK to the serving base station by using a PUCCH. According to this method, an unnecessary transmission(s) and a longer delay may occur. Therefore, in order to compensate for this, the terminal may be instructed to transmit only the PUCCH again.

In an exemplary embodiment, the serving base station may instruct the terminal to transmit all or a part of the HARQ-ACK bits that the terminal has.

The HARQ-ACK/NACK bits may be derived as a result of decoding the DL-SCH received by the terminal or the SL-SCH transmitted by the terminal. The serving base station may instruct the terminal to transmit an HARQ codebook on a PUSCH (or PUCCH). There may be various methods for generating the HARQ codebooks.

In an exemplary embodiment, the HARQ codebook for the DL-SCH(s) received by the terminal and the HARQ codebook for the SL-SCH(s) transmitted by the terminal may generated separately, and may be concatenated into one HARQ codebook. In another exemplary embodiment, according to priorities defined in the technical specification, the HARQ-ACK/NACK bits for the DL-SCH(s) and/or the HARQ-ACK/NACK bits for the SL-SCH(s) may constitute one HARQ codebook while maintaining a predetermined order. In another exemplary embodiment, according to indication of the serving base station, the terminal may transmit all the HARQ-ACK/NACK bits to the serving base station. In this case, the HARQ-ACK/NACK bits may be arranged in the order of the HARQ process identifiers for a given carrier.

The terminal receiving the SL PI may determine that the quality of the PSSCH (and PSCCH) received in the resource (i.e., time and frequency resource) indicated by the SL PI is low. Accordingly, if retransmission for a PSSCH having the same HPID is considered, NACK may be expected even when a soft combining procedure is performed in the decoding procedure. Therefore, it may be preferable that the PSSCH received in the resource overlapping with the resource indicated by the SL PI is not used in the soft combining procedure. Similarly, when considering the initial transmission for the PSSCH, it may be preferable that the PSSCH received in the resource (i.e., symbol or slot in the time domain, RE, PRB, or sub-channel in the frequency domain) overlapping with the resource indicated by the SL PI is not used in the soft combining procedure.

In an exemplary embodiment, the terminal receiving the SL PI may not perform the decoding procedure for the PSSCH received in the resource overlapping the resource indicated by the SL PI. In another exemplary embodiment, the terminal receiving the SL PI may not perform the decoding procedure for REs or code block(s) received in the resource overlapping with the resource indicated by the SL PI or may not store those REs or code block(s) in a (soft) buffer.

Here, not performing the decoding procedure may mean that when the terminal performs the soft combining in the decoding procedure, a value of a log likelihood ratio (LLR) that a part of a codeword has is set to 0 (i.e., REs to which the part of the codeword is mapped are not used in the decoding procedure).

BSR and SR Transmission Method

Since one terminal may be configured to perform both of SL transmission and UL transmission, the serving base station may indicate information (e.g., a logical channel set (LCG) identifier or a logical channel identifier (LCID)) on various types of traffic. For example, an error rate or latency required by the V2X traffic, the eMBB traffic, and the URLLC traffic may be different.

The serving base station may configure a different SR resource (or PUCCH resource or PUCCH-config) for each LCG or each type of traffic (e.g., V2X traffic, eMBB traffic, and URLLC traffic) to the terminal through higher layer signaling. The SR resource may be transmitted at a time when traffic is generated in the terminal in a periodically-configured PUCCH resource. The SR resource may have a different PUCCH frequency resource and time resource (which are interpreted within a slot) for each LCG, and a periodicity of the SR resource may also vary for each LCG.

The priority of the PUCCH transmitting the SR resource may be indicated through higher layer signaling. When the priority is indicated as high, the terminal may not cancel the SR even if the terminal receives a UL PI. On the other hand, when the priority is indicated as low, the terminal may cancel the entire SR or a part of the SR by receiving the UL PI. The SR may correspond to the LCG of the V2X traffic and/or Uu traffic. When the terminal transmits the SR to the serving base station via a PUCCH, the serving base station can know that the traffic has arrived at the terminal. The serving base station may identify an LCG of traffic arriving at the terminal based on the received PUCCH resource. Thereafter, the serving base station may indicate a UL grant the terminal by using a PDCCH. The terminal may transmit a PUSCH in which a UL-SCH and UCI are multiplexed through a resource indicated by the UL grant. The UL-SCH may include not only UL data, but also a MAC message (i.e., buffer status report) representing a status of the buffer. The buffer status report may indicate the amount of traffic per LCG.

According to the conventional technical specification, after the terminal reports the status of the buffer, the terminal does not transmit the SR to the serving base station for a specific prohibition time (e.g., ‘sr-ProhibitTimer’ in the case of NR). Since the serving base station already receives the buffer status report and has more detailed information than the SR, the terminal does not need to additionally transmit the SR. In addition, unnecessary SR (i.e., PUCCH) transmission may act as interferences to other terminals. The prohibition time may be configured differently for each SR.

In case of the terminal to which various LCGs are configured, for a SR for a certain LCG, the prohibition time may be set to be short, thereby adjusting the priority of the corresponding LCG. However, there occurs a case where a long time is required to report the status of the buffer.

In order to report the status of the buffer, the terminal should receive a UL grant to transmit a UL-SCH. The UL grant is given through a PDCCH or an RRC signaling. When a UL grant for an initial transmission UL-SCH is given to the terminal and sufficient processing time is secured, the status of the buffer may be included in the UL-SCH.

Since the terminal cannot multiplex new data in the UL-SCH while retransmitting the UL-SCH, even if the UL-SCH already includes the buffer status, the terminal should wait for a new resource (i.e., a new UL grant or a PUSCH of the next period) for transmitting a PUSCH.

In addition, even when the serving base station transmits the UL grant to the terminal, if a quality that the UL-SCH should have (i.e., target error rate) cannot be satisfied by an MCS of the PUSCH indicated by the UL grant, the UL-SCH cannot be decoded due to an error at the serving base station, and a delay may occur. Therefore, it may be preferable to allow the SR transmission when it is difficult to report the buffer status report, or even while transmitting the PUSCH reporting the status of the buffer.

In an exemplary embodiment, the SR transmission may be allowed before reporting the status of the buffer, or while reporting the status of the buffer.

The prohibition time (e.g., sr-ProhibitTimer) of SR transmission after reporting the status of the buffer may configured by the serving base station through higher layer signaling. This may be a very small value (i.e., values shorter than one slot or ‘0’) depending on the SR. For example, even in symbols in which a PUSCH reporting the status of a buffer is transmitted, the terminal may need to transmit an SR associated with a specific LCG. In this case, the serving base station may set the prohibition time for SR transmission to a small value, so that the terminal can transmit an SR having a higher priority than that of an LCG for a PUSCH while transmitting the PUSCH according to the UL grant. In this case, the terminal may transmit a PUCCH without transmitting the PUSCH.

Relay-Based Group HARQ Operation Method

In order to perform SL transmission, one SUE, one or more DUEs, and one or more relay UEs (RUES) may be considered. The SUE refers to a terminal that generates and transmits data, and performs SL transmission. The DUE refers to a terminal that receives data, and performs SL reception. The RUE refers to a terminal relaying transmission between the SUE and the DUE, and may perform SL transmission and SL reception.

The SUE may operate in the first mode, and may be allocated a resource required for SL transmission from the serving base station. When the SUE operates in the first mode or the second mode, the SUE may broadcast a resource region to be used for SL transmission to a plurality of unspecified terminals by using a reservation channel. The SUE may transmit a SL-SCH one or more times. The SUE may be (pre)configured by higher layer signaling to repeatedly transmit the same SL-SCH twice or more (e.g., blind retransmission).

The DUE may receive the SL transmission from the SUE and receive the SL-SCH or a S-CSI-RS. When decoding the SL-SCH, the DUE may experience an error in some cases. The DUE may be (pre)configured by higher layer signaling to perform HARQ-ACK response for the SL transmission.

In this case, the DUE may feedback an HARQ-ACK (or NACK) to the SUE in order to request retransmission. When the NACK is received, the SUE may retransmit the SL-SCH. If the SUE is configured to perform repetitive transmission (e.g., blind retransmission), the SL-SCH may be transmitted without HARQ-ACK/NACK feedback from the DUE.

The RUE may relay the SL-SCH received from the SUE to the DUE. In this case, the RUE may transmit the same SL-SCH.

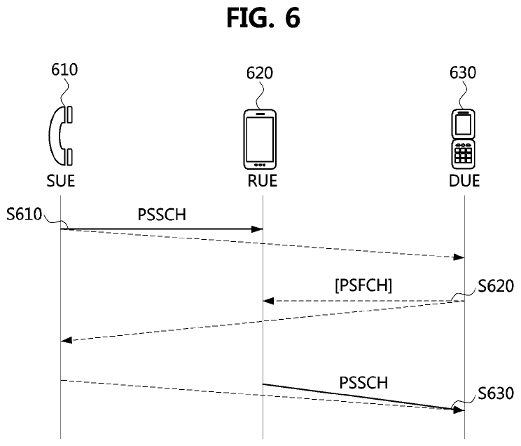

FIG. 6 is a sequence chart illustrating an SL transmission/reception procedure between SUE, DUE, and RUE according to an exemplary embodiment of the present disclosure.

Referring to FIG. 6, a SUE 610 may transmit a SCI through a PSCCH for resource allocation and resource reservation for SL transmission. When the SL transmission uses a SPS transmission resource, transmission of the PSCCH may be omitted. In FIG. 6, only the transmission of PSSCH and PSFCH is shown.

In a first step, the SUE 610 may transmit a SL-SCH (i.e., PSSCH) to an RUE 620 (and/or a DUE 630) (S610). In a second step, the DUE 630 may feedback an HARQ response requesting retransmission to the RUE 620 or the SUE 610 through a PSFCH (S620). On the other hand, the step S620 may be omitted when the blind retransmission is configured. In a third step, the RUE 620 (and/or the SUE 610) may retransmit the SL-SCH to the DUE 630 (S630).

Here, the RUE 620 needs to receive the SL-SCH from the SUE 610 in order to retransmit the SL-SCH. In addition, according to a relaying scheme, the RUE 620 may be instructed to transmit the SL-SCH, which is received from the SUE 610, to the DUE 630 in the same SL resource (i.e., time and frequency resource), or to transmit the SL-SCH to the DUE 630 in a different SL resource.

The RUE 620 may operate in an amplify-and-forward scheme, a decode-and-forward scheme, or other schemes.

In the amplify-and-forward relaying scheme, the RUE 620 may receive a PSSCH in a SL resource for receiving the PSSCH, amplify the received PSSCH through a power amplifier, and transmit the amplified PSSCH in the same or different SL resource as the received SL resource. In this case, the RUE 620 may not demodulate and decode the PSSCH, but may re-scale a power of the PSCCH and relay it to the DUE 630.

Since the process of receiving and processing the PSSCH by the RUE 620 is minimized, if the RUE 620 supports full-duplex communication, the PSSCH can be relayed by using the same resource used for SL transmission and reception. Depending on the processing capability of the RUE 620, when the received PSSCH is transmitted, the frequency resource (e.g., PRB index) may be collectively changed.

If the RUE 620 supports half-duplex communication, the resource of the PSSCH may be defined at least at different times. For example, the RUE 620 may transmit the received PSSCH in a slot different from a slot (or mini-slot) in which the PSSCH is received. In this case, the RUE 620 may store the received PSSCH, and perform more procedures than the procedure of simply amplifying the received PSSCH.

In addition, in order for the RUE 620 to transmit the PSSCH at different times (and/or frequencies), a method of storing the PSSCH should be defined. Since the RUE 620 uses the amplify-and-forward relaying scheme, it may be preferable to store the PSSCH received by the RUE 620 in a memory element (or soft buffer) within the RUE 620. In order to deliver the PSSCH, the RUE 620 may use a (pre)configured SL resource or a SL resource indicated by the PSCCH, allocate an appropriate power to (i.e., amplify) the received PSSCH, and transmit the amplified PSSCH to the DUE 630.

In this process, the RUE 620 may not allocate a new PSSCH DM-RS and may not demodulate or decode the PSSCH. However, after receiving the PSSCH, the RUE 620 may transmit the PSSCH to the DUE 630 in a new SL resource having a frequency and time different from the frequency and time of the SL resource in which the PSSCH is received.

In an exemplary embodiment, the SL resource used when the RUE 620 transmits the PSSCH to the DUE 630 may be indicated by an SCI belonging to a PSCCH that the RUE 620 receives from the SUE 610 as the same or different resource as the SL resource in which the PSSCH has been received from the SUE 610. According to another method, the RUE 620 may receive a PSFCH from the DUE 630, and may use the same frequency resource and time resource (i.e., time resource defined within a slot) as the SL resource in which the PSSCH has been received from the SUE 610. According to yet another method, the SL resource to be used by the RUE 620 may be occupied by the SUE 610 using a reservation channel, and the RUE 620 may utilize the reserved SL resource as it is.

The new SL resource allocated to the RUE 620 may have the same or different number of REs as the SL resource in which the PSSCH has been received. When the SL resource in which the PSSCH has been received and the new SL resource have the same number of REs and the same shape of the SL resources, the RUE 620 may map the received REs one-to-one with the REs to be transmitted. On the other hand, when they have the different numbers of REs, the REs received by the RUE 620 may not correspond one-to-one with the REs to be transmitted.

In case that the PSSCH is amplified-and-forwarded while the number of REs of the PSSCH is reduced, the RUE 620 may map a resource belonging to the remaining SL resources excluding some resources (i.e., some symbols and/or some sub-channels) of the resources of the PSSCH as the new SL resources. That is, the RUE 620 may transmit only a part of the received PSSCH.

In case that the PSSCH is amplified-and-forwarder while the number of Res is increased, the RUE 620 may repeatedly map some (i.e., some symbols and/or some sub-channels) of the resources of the PSSCH as the new SL resource. For example, the RUE 620 may transmit some symbols belonging to the PSSCH to the DUE 630 two or more times.

Meanwhile, the DUE 630 may combine the PSSCH received from the SUE 610 and the PSSCH received from the RUE 620 to decode the SL-SCH.

In the proposed decode-and-forward relaying scheme, the RUE 620 may receive a PSSCH and decode a SL-SCH. When the decoding of the SL-SCH is successful, the RUE 620 may perform an encoding process on the decoded SL-SCH to generate a PSSCH again, and transmit the PSSCH generated in the same or different SL resource as the SL resource in which the PSSCH is received.

Since the RUE 620 needs a processing time to decode and re-encode the SL-SCH, the SL resource in which the PSSCH is received and the SL resource in which the PSSCH is transmitted may be different at least in terms of time. For example, the RUE 620 may relay the PSSCH by using different slots (or mini-slots). However, if the RUE 620 fails to decode the SL-SCH (i.e., NACK), even when it is encoded again and transmitted to the DUE 630, the DUE 630 may not succeed in decoding the corresponding SL-SCH.

Since the RUE 620 decodes the SL-SCH, information for decoding the PSSCH is needed. For example, it may be preferable that the RUE 620 knows the RNTI or scrambling sequence of the SUE 610.

The SL resource used when the RUE 620 forwards the PSSCH to the DUE 630 may be indicated as a SL resource that is the same or different resource as the SL resource indicated by the SCI received from the SUE 610 through the PSCCH. According to another method, when the RUE 620 receives the PSFCH from the DUE 630 and determines NACK, the RUE 620 may use the same time and frequency resource as the SL resource indicated by the SUE 610. According to yet another method, the SL resource occupied by the SUE 610 using a reservation channel may be utilized as the SL resource to be used by the RUE 620.

When the new SL resource is allocated to the RUE 620, the number of REs of the new SL resource may be the same as or different from the number of REs of the SL resource where the RUE 620 has received the PSCCH. Since the RUE 620 decodes the SL-SCH, even when the amount of resources of the PSSCH is changed, the RUE 620 may configure the PSSCH by performing rate matching.

The DUE 630 may combine the PSSCHs received from the SUE 610 and the RUE 620 to decode the SL-SCH.

In an exemplary embodiment, the RUE 620 may operate in a demodulate-and-forward relaying scheme. The RUE 620 may receive a PSSCH DM-RS and estimate a channel response. By using the estimated channel response, a SL-SCH of the PSSCH may be demodulated. According to the conventional scheme (i.e., decode-and-forward relaying scheme), the demodulated SL-SCH may be input to a channel decoder. However, according to a proposed method, the demodulated SL-SCH may not be input to the channel decoder and may be stored in a soft buffer. The demodulated SL-SCH may be composed of a bit stream (or modulation symbols (e.g., QPSK, or QAM symbols)).

When the demodulated SL-SCH(s) are stored in the soft buffer, they are not stored in an arbitrary order, but may follow an order defined in the technical specification (and/or an order indicated by the PSCCH(s)). Here, as an example of the order indicated by the PSCCH(s), redundancy version(s) (RV(s)) for SL-SCH(s) constituting the PSSCH(s) may be followed.

When the RUE 620 needs to transmit (i.e., (pre)configured to continuously transmit or instructed by the PSCCH to transmit) the SL-SCH, the RUE 620 may re-modulate the demodulated SL-SCH stored in the soft buffer. Thereafter, the RUE 620 may newly allocate a PSSCH DM-RS, amplify the PSSCH (i.e., including the newly modulated SL-SCH and the PSCCH DM-RS) with an appropriate power, and transmit it to the DUE 630. The DUE 630 may combine the PSSCHs received from the SUE 610 and the RUE 620 to decode the SL-SCH.

In this case, the resource used by the RUE 620 to transmit the PSSCH (and resource of the PSSCH DM-RS) may be (pre)configured or given by the PSCCH. The PSCCH may indicate the SL resource (i.e., time and frequency resource) to be used by the PSSCH (and resource of the PSSCH DM-RS), and may indicate the RV of the SL-SCH.

Since the RUE 620 may fetch a necessary bit stream (or demodulation symbols) from the soft buffer, the amount of resource of the PSSCH to be transmitted by the RUE 620 and the amount of resource of the PSSCH received by the RUE 620 may not need to be the same. Here, the amount of resource may mean the number of REs or the length of a bit stream.

The RUE 620 may know the length (or number) of the bit stream (or demodulation symbols) of the SL-SCH stored in the soft buffer according to the amount of resource allocated to the PSSCH to be transmitted. The RUE 620 may convert the bit stream of the SL-SCH into modulation/demodulation symbols through a modulation procedure. The above procedure may be omitted when the modulation/demodulation symbols of the SL-SCH are stored in the soft buffer.

The RUE 620 may map the modulation/demodulation symbols to the allocated resource according to a rule defined in the technical specification. For example, such the mapping may be performed on the allocated REs. The mapping may be performed in the order of subcarriers within the same symbol, and then in the order of symbols. When multiple antenna ports are used, the mapping may be performed according to the order of antenna ports, the order of subcarriers, and the order of symbols. Among the REs, the PSSCH may not be mapped to the REs occupied by the PSSCH DM-RS, ZP CSI-RS, or PT-RS allocated by the RUE 620 (or other terminal) for use, or the PRBs occupied by SS/PBCH blocks.

The exemplary embodiments of the present disclosure may be implemented as program instructions executable by a variety of computers and recorded on a computer readable medium. The computer readable medium may include a program instruction, a data file, a data structure, or a combination thereof The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. A method of a source terminal in sidelink communication, the method comprising:
receiving configuration information of configured sidelink resources from a base station;
transmitting a first physical sidelink shared channel (PSSCH) to a destination terminal through a first SL resource according to the configuration information;
receiving a negative acknowledgement (NACK) for the first PSSCH from the destination terminal; and
in response to the NACK for the first PSSCH, retransmitting the first PSSCH to the destination terminal through a second SL resource according to the configuration information.

2. The method according to claim 1, wherein the configured sidelink resources are configured semi-persistently.

3. The method according to claim 1, wherein the first PSSCH is retransmitted through the second SL resource when a second PSSCH to be initially transmitted to the destination terminal through the second SL resource is not selected.

4. The method according to claim 3, wherein when the second PSSCH is not selected to be initially transmitted through the second SL resource, the second PSSCH is initially transmitted to the destination terminal through a third SL resource, the third resource is allocated based on the configuration information, and the third SL resource occurs later than the second SL resource.

5. The method according to claim 1, wherein the retransmitting of the first PSSCH is indicated to the destination terminal through sidelink control information (SCI).

6. The method according to claim 5, wherein the retransmitting of the first PSSCH is indicated to the destination terminal through a new data indicator (NDI), hybrid automatic repeat request (HARQ) process number identifier (ID), and/or redundancy version (RV) included in the SCI.

7. The method according to claim 1, wherein the NACK for the first PSSCH is not reported by the source terminal to the base station.

8. The method according to claim 1, further comprising: before the retransmitting,
determining whether to select a second PSSCH to be initially transmitted through the second SL resource; and
in response to determining that the second PSSCH to be initially transmitted is selected, initially transmitting the second PSSCH through the second SL resource instead of the first PSSCH.

9. A method of a destination terminal in sidelink communication, the method comprising:
receiving a first physical sidelink shared channel (PSSCH) from the source terminal through a first SL resource according to configured sidelink resources;
transmitting a negative acknowledgement (NACK) for the first PSSCH to the source terminal; and
in response to the NACK for the first PSSCH, receiving the first PSSCH retransmitted from the source terminal through a second SL resource according to the configured sidelink resources.

10. The method according to claim 9, wherein the configured sidelink resources are configured semi-persistently.

11. The method according to claim 9, wherein the first PSSCH is retransmitted through the second SL resource when a second PSSCH to be initially transmitted from the source terminal through the second SL resource is not selected by the source terminal.

12. The method according to claim 11, wherein when the second PSSCH is not selected to be initially transmitted through the second SL resource, the second PSSCH is initially transmitted from the source terminal through a third SL resource, the third resource is allocated according to the configured sidelink resources, and the third SL resource occurs later than the second SL resource.

13. The method according to claim 9, wherein the retransmitting of the first PSSCH is indicated by the source terminal to the destination terminal through sidelink control information (SCI).

14. The method according to claim 13, wherein the retransmitting of the first PSSCH is indicated by the source terminal through a new data indicator (NDI), hybrid automatic repeat request (HARQ) process number identifier (ID), and/or redundancy version (RV) included in the SCI.

15. The method according to claim 9, wherein the NACK for the first PSSCH is not reported to the base station.
